(19) United States
(12) Patent Application Publication
(10) Pub. No.: US 2016/0221831 A1
(43) Pub. Date: Aug. 4, 2016

(54) GRAM-SCALE FRACTIONATION OF NANODIAMONDS BY DENSITY GRADIENT ULTRACENTRIFUGATION

(71) Applicant: KING ABDULLAH UNIVERSITY OF SCIENCE AND TECHNOLOGY, Thuwal (SA)

(72) Inventors: Osman M. BAKR, Thuwal (SA); Wei PENG, Thuwal (SA)

(73) Assignee: KING ABDULLAH UNIVERSITY OF SCIENCE AND TECHNOLOGY, Thuwal (SA)

(21) Appl. No.: 15/021,298

(22) PCT Filed: Sep. 12, 2014
(86) PCT No.: PCT/IB2014/002632

§ 371 Date: Mar. 11, 2016

Related U.S. Application Data
(60) Provisional application No. 61/876,852, filed on Sep. 12, 2013.

(51) Int. Cl. C01B 31/06

(52) U.S. Cl. CPC C01B 31/065

(57) ABSTRACT

Disclosed herein are compositions comprising purified nanoparticles and methods of generating and using the same, preferably a composition comprising purified nanodiamonds, wherein the diamond nanocrystals have a size distribution equal to or between 1 and 10 nm and a method of purifying the composition comprising nanoparticles, preferably nanodiamonds, comprising: centrifuging at least two tubes comprising a first sample comprising nanoparticles, preferably nanodiamonds, to create a density gradient, wherein the at least two tubes are tilted at least 45°; and collecting a second composition containing purified nanoparticles, preferably nanodiamonds.

### CROSS-REFERENCE TO RELATED APPLICATIONS

This application claims the benefit of priority of U.S. Provisional Patent Application No. 61/876,852, filed on Sep. 12, 2013, which is hereby incorporated by reference in its entirety.

### BACKGROUND OF THE INVENTION

1. Field of the Invention

The present invention relates generally to the field of nanoparticles. More particularly, it concerns compositions comprising purified nanoparticles and methods of generating the same.

2. Description of Related Art

Size is a critical characteristic of nanoparticles (NPs). It directly or indirectly influences their optical and electronic properties, interactions with bio- and macro-molecules, and self-assembly behaviors (Talapin, et al., 2010; Verma & Stellacci, 2010). Many advances in understanding and using NPs of some materials (e.g., noble metals [Frens, 193] and metal chalcogenides [Murray, et al., 1993]) were realized only when practical approaches to synthesizing them with tunable size distributions became available. A purely chemical approach to optimizing size distribution is time consuming and, in many instances (e.g., nanodiamonds [Mocahalin, et al., 2012]), not viable. Thus, post-synthetic size-sorting techniques have been developed to fractionate NPs (Larionova, et al., 2006; Ghosh, et al., 2010; Ge, et al., 2009; Chukhaeva, 2004; Sun, et al., 2010). Unfortunately most reported NP separation methods to date involve low yields (micrograms to a few milligrams) and may not be practical on large scales.

Density gradient ultracentrifugation (DGU) (Graham, 2001) is an attractive gravitation-based separation approach, because it can be performed in both aqueous and organic solvents, does not require a stationary phase, and does not require the nanoparticle species to be electrically charged or magnetic. Biologists originally pioneered DGU in the 1930s for the separation of subcellular organelles and bio-macromolecules (Brakke, 1967). Species were separated either by their sedimentation rate, which is known as rate-zonal DGU (RZDGU), or by their density when their isopycnic point (IP) inside the density gradient was reached. The latter method is referred to as IPDGU (Graham, 2001). It has been used frequently in the last decade in the study of nanomaterials. For example, IPDGU has been applied with great success to carbon nanotubes (Arnold, et al., 2006) and grapheme (Green & Hersam, 2009). However, IPDGU is not applicable to other denser materials, because such materials lie outside the density range of most liquids. There are also notable reports of nanoparticles separated by RZDGU, such as metal nanocrystals (Ge, et al., 2009; Steinigeweg, et al., 2011), semiconductor quantum dots (Bai, et al., 2010), and chemically modified grapheme (Sun, et al., 2010). In both IPDGU and RZDGU, the reported scale of separation is typically modest due to (i) the tedious manual work required to prepare the gradient in the centrifuge tube, and (ii) the difficulty of collecting replicated fractions from the tube without disturbing its contents.

Nanodiamonds have attracted the interest of researchers in nanomedicine, surface science, and photonics for their outstanding mechanical hardness, chemical inertness, expected biocompatibility, as well as for their unique electronic and optical properties (particularly of their defect states) (Mochalin, et al., 2012). Detonation nanodiamonds (DNDs) are the most widely studied types of diamond nanoparticles because of their large-scale commercial availability, affordability, and ease of tailoring their surface functionality (Schrand, et al., 2012). Recent studies have fuelled interest in DNDs by demonstrating their perspectives for therapeutic and drug delivery applications (Chen, et al., 2009; Schrand, et al., 2009; Chow, et al., 2011).

However, the polydispersed size distribution of DNDs remains a major obstacle to elucidating their fundamental properties with which various areas of applicability are correlated. DNDs are polydispersed on two levels. They are composed of primary particles (<10 nm) that exist both as single particles and aggregates in a wide size range of ten to hundreds of nanometers (Mochalin, et al., 2012). Significant progress has been made in obtaining stable colloidal dispersions of DNDs with fewer and smaller aggregates. For example, several effective disintegration methods such as annealing, plasma treatment, and bead milling have been used to reduce the size of the aggregates (Liang, et al., 2011; Osawa, 2007; Kruger, et al., 2005; Gibson, et al., 2009). However, obtaining monodispersed or narrowly distributed nanodiamonds has remained difficult with these disintegration methods. Multi-step ultracentrifugation (i.e., pelleting) (Larionova, et al., 2006; Chukhaeva, 2004; Shenderova, et al., 2006; Korobov, et al., 2013; Williams, et al., 2010) was attempted to address the polydispersity issue, yet with limited success: multimodal size analysis showed that the sizes of the particles were in a large range, with multiple peaks in each fraction, suggesting that fractionation by pelleting will not achieve efficient size-separation accuracy and yield (Larionova, et al., 2006). This deficiency derives from the pelleting scheme: pellets collected at each time-step contain particles with a broad range of sedimentation coefficients, because the centrifugation initiates while the particles are uniformly dispersed throughout the tube. In addition, the method required many centrifugation steps—another limiting parameter in the process of producing size-controlled nanoparticles on large scale.

It is worth noting that large aggregates of DNDs are not necessarily undesirable. For example, DND aggregates with a size of ˜100 nm can be used to achieve photonic structures (Grichko, et al., 2008); while those with a size of ˜50-100 nm may find use in UV protection coatings and sunscreens (Shenderova, et al., 2007). In contrast, for drug delivery and biological studies, DNDs smaller than 10 nm are needed (Schrand, et al., 2009). Efficient methods that can extract monodispersed fractions of both large aggregates and primary particles would be valuable to researchers and industrialists who aim to work with nanoparticles.

Diamonds possess outstanding mechanical robustness, chemical inertness, biocompatibility, and optical transparency over a broad range of wavelengths (200-2000 nm) (Aharonovich, et al., 2011; Sharda, et al., 2001). Moreover, diamonds can accommodate over 500 types of defect color-centers (DCCs), many of which are optically active, with long emission and spin coherence times, as well as thermally stable and resistant to photo-bleaching (Aharonovich, et al., 2011). These characteristics of DCCs, combined with the properties of the host diamond crystal, have enabled the demonstration of many novel applications in metrology (Phar, et al., 2012), sensing (Mamin, et al., 2013), super-resolution microscopy (Lai, et al., 2013; Maurer, et al., 2010), biolabeling (Barnard, et al., 2009; McGuinness, et al., 2011), magnetometry (Balasubramanian, et al., 2008), quantumcomputation, and quantum communications (Neumann, et al., 2010; Hausmann, et al., 2012a; Hausmann, et al., 2012b). For example, the negatively charged and brightly emitting nitrogen-vacancy (NV) center, which is the most widely studied DCC in diamonds, has been used as a nanoscale NMR to map and sense magnetic spins in individual molecules (Mamin, et al., 2013; Staudacher, et al., 2013), a stable source of single photons at room temperature (Mizuochi, et al., 2012), a highly sensitive temperature sensor, and a quantum qubit that can be manipulated with photons and magnetic fields (Grotz, et al., 2012). The ability to control the placement and concentration of the DCC with respect to the specific nanostructure, such as a photonic cavity or a tip of a scanning probe, is essential for such applications (Pezzagna, et al., 2011).

Although top-down approaches like focused ion-beam implantation (Pezzagna, et al., 2011a; Pezzagna, et al., 2011b; Chang, et al., 2008) have succeeded in the placement of individual DCCs with nanometer precision within functional nanostructures in proof-of-concept devices, they remain challenging in terms of scalability and cost.

Alternatively, DCCs may be embedded in colloidally dispersed diamond nanocrystals (DNCs) (Morita, et al., 2008; Mohan, et al., 2010) thereby combining the desirable properties of diamonds with the potential benefits of supramolecular nanoparticle chemistry. The surface of a DNC can be appended with various functional moieties and molecules (Faklaris, et al., 2009; Vial, et al., 2008; Takimoto, et al., 2010) that provide an added dimension of molecular recognition and bottom-up-directed self-assembly (Vaijayanthimala & Chang, 2009). Indeed, by tailoring the chemical interaction between the nanoparticle and specifically patterned patches on a substrate (e.g., by conventional photolithography, soft lithography, or dip-pen nanolithography), researchers are able to control the placement of individual nanoparticles and of ensembles of nanoparticles on the substrate with nanometer precision (Jones, et al., 2011).

However, several challenges need to be overcome before such a scheme could become a viable way to direct the placement of DCCs on functional nanostructures. Ideally the DNCs have to be uniformly implanted such that each nanoparticle in the ensemble contains a similar and controllable DCC density (number per unit volume). In reality, studies have shown that the density of DCCs is strongly and inversely correlated with the size of the crystal (Rabeau, et al., 2007; Bradac, et al., 2009; Smith, et al., 2009). Unfortunately, as-synthesized DNCs (whether by detonation [Mochalin, et al., 2011] or by high pressure high temperature (HPHT) [Faklaris, et al., 2009; Boudou, et al., 2009]) have extremely broad size distributions.

### SUMMARY OF THE INVENTION

Disclosed herein are compositions comprising purified nanoparticles and methods of generating the same. In some aspects, disclosed herein are purified nanoparticles and compositions comprising the same. These purified nanoparticles have a relatively uniform size distribution, which renders them useful for a number of applications.

The purified nanoparticles have a relatively consistent size, which improves their usefulness in precise applications. In some embodiments, the purified nanoparticles have a size distribution of no more than 1, 2, 3, 4, 5, 6, 7, 8, 9, or 10 nm, or any size derivable therein. In some embodiments, the nanoparticles have a size distribution of no more than 10 nm. In some embodiments, the nanoparticles have a size distribution of no more than 5 nm. In some embodiments, the nanoparticles have a size distribution of no more than 4 nm. In some embodiments, the nanoparticles have a size distribution of no more than 3 nm. In some embodiments, the nanoparticles have a size distribution of no more than 2 nm. In some embodiments, the nanoparticles have a size distribution of no more than 1 nm. In some embodiments, the purified nanoparticles are defined by the percentage of aggregates in the composition. In some embodiments, aggregates of nanoparticles comprise less than 50, 45, 40, 35, 30, 25, 20, 15, 10, 5, 4, 3, 2, or 1% by weight of the composition, or any percent derivable therein. In some embodiments, aggregates of nanoparticles comprise less than 10% by weight of the composition. In some embodiments, aggregates of nanoparticles comprise less than 5% by weight of the composition. In some embodiments, the size distribution of the nanoparticles has a standard deviation of 1 or less.

The purified nanoparticles may be of any appropriate size. In some embodiments, the nanoparticles have a mean particle size of 5 nm. In some embodiments, the nanoparticles have a mean particle size of 6 nm. In some embodiments, the nanoparticles have a mean particle size of 7 nm. In some embodiments, the nanoparticles have a mean particle size of 8 nm. In some embodiments, the nanoparticles have a mean particle size of 9 nm. In some embodiments, the nanoparticles have a mean particle size of 10 nm.

The composition may contain a variety of amounts of nanoparticles. In some embodiments, the composition comprises 1, 2, 3, 4, 5, 10, 15, 20, 25, 30, 35, 40, 45, 50, 60, 70, 80, 90, 100, 125, 150, 175, 200, 250, 300, 350, 400, 500, 600, 700, 800, 900 mg of nanoparticles, or more or any amount derivable therein. In some embodiments, the composition comprises at least 20 mg of nanoparticles. In some embodiments, the composition comprises at least 50 mg of nanoparticles. In some embodiments, the composition comprises at least 100 mg of nanoparticles. In some embodiments, the composition comprises at least 200 mg of nanoparticles. In some embodiments, the composition comprises at least 300 mg of nanoparticles. In some embodiments, the composition comprises at least 400 mg of nanoparticles.

The nanoparticles may be any appropriate material. In some embodiments, the nanoparticles are nanodiamonds. In some embodiments, the composition comprising nanoparticles may comprise a plurality of nanodiamonds. In some embodiments, the nanodiamonds may be further modified. In some embodiments, one or more of the nanodiamonds present may contain nitrogen vacancy centers.

In other aspects, disclosed herein are methods of purifying a composition comprising nanoparticles or of purifying nanoparticles comprising (a) centrifuging at least two tubes comprising a first sample comprising nanoparticles to create a density gradient, wherein the at least two tubes are tilted at least 45°; and (b) collecting a second composition containing purified nanoparticles. The density gradient may be either a continuous or a stepwise gradient. In some embodiments, the method further comprises extracting the purified nanoparticles from the second composition. In some embodiments, extracting the purified nanoparticles is performed by dialysis.

There may be any appropriate or available number of tubes, including but not limited to 1, 2, 3, 4, 5, 6, 7, 8, 9, 10, or more. The tubes may be tiled at any appropriate angle. In some embodiments, the angle is, is at least, or is at most 45, 50, 55, 60, 65, 70, 75, 80, 85, or 90° or any angle derivable therein. In some embodiments, the tubes are tilted at least 50°. In some embodiments, the tubes are tilted at least 60°. In some embodiments, the tubes are tilted at least 70°. In some embodiments, the tubes are tilted at least 80°. In some embodiments, the tubes are tilted at least 90°.

The sample may be any sample comprising nanoparticles. In some embodiments, the sample comprising nanoparticles is a stable dispersion. The stable dispersion may be obtained in any appropriate manner. In some embodiments, the stable dispersion is prepared by salt-assisted dry ball milling, ultrasonification, or both. In some embodiments, the stable dispersion is prepared by salt-assisted dry ball milling and ultrasonication.

The methods disclosed herein are designed to be time efficient. In some embodiments, the process is completed within 1, 2, 3, 4, 5, 6, 7, 8, 9, or 10 hours, or any time derivable therein. In some embodiments, the process is completed within 4 hours. In some embodiments, the process is completed within 2 hours.

The centrifugation may be performed at any appropriate speed and for any appropriate time, dependent on the particle size desired. In some embodiments, the centrifugation is performed at, at least, or at most at 15,000, 20,000, 25,000, or 30,000 rpm, or any speed derivable therein. In some embodiments, the centrifugation is performed at 20,000 rpm. In some embodiments, the centrifugation is performed at 30,000 rpm. In some embodiments, the centrifugation is performed for, for at least, or for at most 1, 2, 3, 4, 5, 6, 7, 8, 9, 10, 15, 20, 30, 40, 50, 60, 70, 80, 90, or 100 minutes, or any time derivable therein. In some embodiments, the centrifugation is performed for at least 5 minutes. In some embodiments, the centrifugation is performed for at least 30 minutes. In some embodiments, the centrifugation is performed for at least 50 minutes. In some embodiments, the centrifugation is performed for at least 75 minutes.

In some embodiments, the method further comprises (d) preparing a dispersion comprising the purified nanoparticles; (e) centrifuging at least two tubes comprising the dispersion containing purified nanoparticles to create a density gradient, wherein the at least two tubes are tilted at least 45°; and (f) collecting a third composition containing purified nanoparticles. The two centrifuging steps may be performed at the same or at different speed. In some embodiments, the centrifuging of step (a) is performed at the same speed as the centrifuging of step (e). In some embodiments, the centrifuging of step (a) is performed at a different speed from the centrifuging of step (e). The tubes may also be tilted at the same or different angles in the two steps. In some embodiments, the at least two tubes of step (a) are tilted at the same angle as the at least two tubes of step (e). In some embodiments, the at least two tubes of step (a) are tilted at a different angle from the at least two tubes of step (e).

In some embodiments, the nanoparticles may comprise diamond nanocrystals (DNCs.) In some embodiments, the method may further comprise preparing a film comprising the DNCs. In some embodiments, the method may further comprise irradiating the DNCs to produce nitrogen-vacancy centers in one or more of the DNCs.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the method being employed to determine the value, or the variation that exists among the study subjects.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1D A) A visual comparison of mpDND solutions at different concentrations. Left: 40 mg/mL; Right: 4 mg/mL; B) The size distribution of mpDNDs by DLS. The mean size and standard deviation are indicated in the inset; C) XRD spectrum of the mpDNDs; D) FTIR spectrum of the mpDNDs. Major peaks are marked with arrows in the graph.

FIG. 2 Schematic illustration of the RZDGU procedure: 1) layering a light and a heavy solution; 2) tube tilt and rotation to form a continuous density gradient; 3) layering the sample solution; 4) ultracentrifugation; 5) collecting fractions.

FIG. 3 Sedimentation profiles of mpDNDs in gradients after ultracentrifugation. Left: First iteration: 20,000 rpm for 50 minutes; the broad sedimentation band was equally divided into F′ 1 to F′ 6, while materials left at the bottom of the tube were designated F′ 7. Right: F′ 1 was collected and subjected to a second iteration (30,000 rpm for 1.25 hours). The 18 mm of the broad band near the top of the gradient was divided into F″ 1-F″ 6, spaced 2 mm, 2 mm, 3 mm, 3 mm, 4 mm, and 4 mm, respectively.

FIGS. 4A-4B A) This photograph of F′ 1-7 at roughly the same concentrations shows difference in color due to the size-dependent Rayleigh scattering by each fraction. B) The size distributions of seven fractions collected in the first iteration (F′ 1-F′ 7) and the reconstructed size distribution of mpDNDs from the mass-weighted sum (MWS) of the 7 fractions. The table in the inset presents the mean values and standard deviations of these size distributions.

FIG. 5 XRD spectra of the F′ 1, 3, 7 and the mpDNDs.

FIG. 6 The size distributions of six fractions collected in the second iteration as measured by DLS. The table in the inset gives the mean values and standard deviations of these size distributions.

FIG. 7 The size distributions of the first 3 fractions collected in the second iteration by AUC. The tables in the insets give the mean values and standard deviations of each size distribution.

FIGS. 8A-8C Transmission electron microscopy (TEM) images and corresponding size distribution histograms of the first three fractions (statistics on ˜150 particles) collected in the second iteration: a) F″ 1, b) F″ 2 and c) F″ 3 The scale bars in the TEM images are all 40 nm.

FIG. 9 Size distribution of DNDs at different concentrations by DLS.

FIG. 10 UV-vis spectrum of the solution of DNDs at a controlled concentration.

FIG. 11 Size distribution of the mpDNDs and NanoAmando particles at a controlled concentration by DLS.

FIG. 12 The distribution of the sucrose concentration along the tubes of two gradients.

FIG. 13 Photos of the mpDNDs in the two gradients after centrifugation at the speed of 20,000 rpm for 50 min. Left: Gradient 1; Right: Gradient 2.

FIG. 14 Photos of the mpDNDs in the two gradients after a subsequent centrifugation at 30,000 rpm for 1 h following the centrifugation cycle at the speed of 20,000 rpm for 50 min. Left: Gradient 1; right: Gradient 2.

FIG. 15 Photos of DNDs from F′ 1 in Gradient 2 after centrifugation at 30,000 rpm for different times, from left to right: 1 h, 1.25 h, 1.5 h, 1.75 h.

FIGS. 16A-16G TEM images of the 7 fractions collected in the first iteration of the fractionation procedure, a)-g) F′ 1-7 correspondingly. The scale bars in the images are all 20 nm.

FIG. 17 Zeta potentials of F′ 1-7; the blue error bars indicate the standard deviations of each value.

FIGS. 18A-18B (A (top panel)) Raw experimental and simulated data, (B (bottom panel)) residuals of sedimentation coefficients of the AUC analysis of F″ 1.

FIGS. 19A-19C Sedimentation coefficient distribution of a) F″ 1., b) F″ 2 and c) F″ 3.

FIG. 20 Linear fitting of the relation between the densities and concentrations of mpDND solutions.

FIGS. 21A-21C-(A) DNC dispersion in water, (B) a representative TEM image of a sample taken from the solution. Inset shows the selected-area electron diffractogram. (C) Powder XRD of the material dried from the DNC dispersion.

FIGS. 22A-22B-(A) Image of a centrifuge tube containing DNC dispersion centrifuged in a density gradient. The resulting DNC fractions were collected and labeled depending on their position along the height of the tube. (B) TEM images of fractions f1, f5, f10, f15, and f20. The inset of each image shows the average size and standard deviation of the particles in each fraction.

FIGS. 23A-23B-(A) SEM image of fractionated diamond from layer 10 spincoated on an aminosilanized substrate. (B) Thresholded binary image from (A) used to determine the particle density.

FIGS. 24A-24C-Optical characterization of single NV luminescence. (A) Confocal 650-800 nm fluorescence image of drop-cast milled nanodiamond from f20 without irradiation. (B) and (C) Emission spectra and photon autocorrelation functions of NV centers within a focused laser spot placed in the regions indicated by arrows in (A).

FIGS. 25A-25C-Fluorescence characterization of irradiated nanodiamond films. (A) Confocal fluorescence images of f1, f5, f10, f15, and f20. The scale bar is 10 microns, and the image contrast is displayed from 0-5×10⁴ counts per second. (B) Emission spectra from regions indicated by arrows in (A). Single peaks are the result of CCD detector noise. (C) The average NV content of nanocrystals as a function of size was estimated from the integrated luminescence intensity and nanodiamond film density. The error associated from each point is approximately 6% on the y-axis based on fluorescence from ˜10⁵ particles per image. The red solid curve is a least squares fit to y−A exp(−Bx), and the blue dotted curve is a fit to y−Ax³.

### DESCRIPTION OF ILLUSTRATIVE EMBODIMENTS

Disclosed herein is a large-scale RZDGU method and use of the same to fractionate highly concentrated colloidal dispersions of DNDs. By using a parallel semi-automated approach to gradient preparation and fraction collection, an unassisted operator (with moderate effort) is able to fractionate ˜400 mg of DNDs into several narrow size fractions in one centrifugation cycle with a total combined time around two hours.

Furthermore, the smallest size fractions may also be subjected to a second cycle of RZDGU to obtain highly monodispersed primary particles and to provide precise insights into their size distributions by dynamic light scattering, analytical ultracentrifugation, transmission electron microscopy, and powder X-ray diffraction.

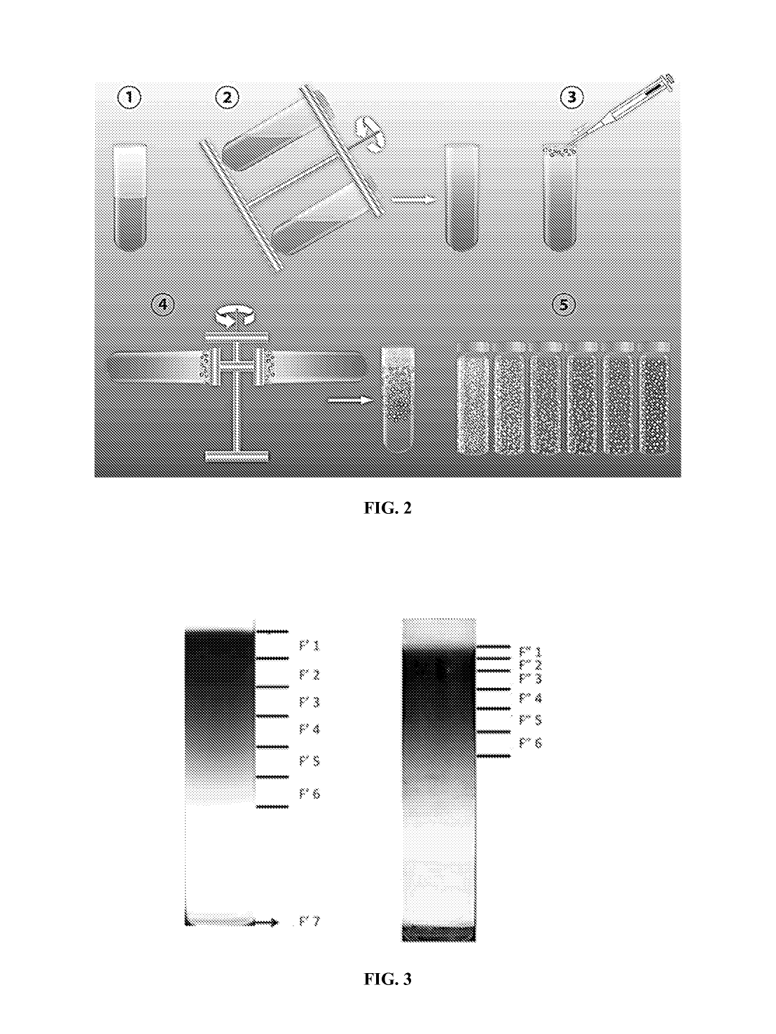

One embodiment of the process of preparing the density gradient and fractionating the particles in the RZDGU method is illustrated in FIG. 2. In some embodiments, two solutions of different concentrations of sucrose are layered in the centrifugation tube consecutively (light top, heavy bottom). A continuous density gradient forms while the tube is tilted at a specific angle and rotated at a predetermined angular velocity and length of time. The tilt-rotator can preferably hold multiple tubes simultaneously. Sample solutions are then layered on top of the as-prepared gradient and centrifuged to form a nanoparticle sedimentation profile along the length of the tube. Nanoparticles with different sedimentation coefficients reached different positions and were then collected separately. Fractions are collected from the one or more identically processed tubes simultaneously, which largely increases the process capacity and reproducibility. This fractionation procedure, including the density gradient preparation, sample loading, centrifugation and fraction collection should take around two hours, including the variable centrifugation time.

The RZDGU method can be carried out with various density gradient media, for example: iodixanol, PVP, glycerol, agarose and sucrose (Komatsu & Wang, 2010). With regard to the selection of media for the density gradient, the solubility of sample nanoparticles in the gradient and the ability to separate the samples from the gradient are important considerations. Concentrated sucrose solutions are very viscous, which helps to minimize the diffusional spreading of nanoparticles (Graham, 2001). Furthermore, sucrose is non-toxic (necessary for biological applications) and both DNDs and sucrose can be co-solubilized in water, which ensures the dispersion of DNDs in the gradient. In addition, DNDs can be easily separated from the sucrose solution through dialysis or ultracentrifugation.

A second important consideration is the choice between continuous (Steinigeweg, et al., 2011) or stepwise (Ge, et al., 2009) profiles of the density gradient. Stepwise gradients usually contain several layers of different concentrations of gradient medium, which suggests that a corresponding number of density plateaus exist in the gradient. In most cases, the number of necessary gradient layers is determined by the number of fractions that are desired, because the fractionation resolution within one uniform layer is usually very low and it is not effective to divide a single layer into two or more fractions for the purpose of improving the size-separation resolution (Sun, et al., 2010). Considering this, stepwise density gradients are a good choice for fractionating discretely or narrowly distributed samples. In comparison, continuous density gradients allow continuously and widely distributed samples to be fractionated. A continuous density gradient can be prepared in a reproducible and scalable way, whereas it can be difficult to replicate a stepwise density gradient from tube to tube as the number of layers of solutions increases because positioning the interfaces between different layers is subject to the appreciation of the operator. In addition, inadvertent mixing between adjacent layers can occur during the process of layering the gradient. These two effects further limit the applicability of stepwise density gradients to fractionating small samples, each with a limited number of fractions. In contrast, the fractionation resolution of continuous density gradients is only limited by the diffusional spreading of the nanoparticles as they sediment down the tube. Other important factors affecting the quality of the fractionation to consider are the slope of the density gradient, the viscosity and density at the starting end of the gradient, the centrifugation speed and the duration of centrifugation.

One method of making a continuous density gradient includes two steps: the first step is a small-angle rotation for a certain period of time and the second step is a larger-angle rotation for a shorter time. Both the rotation time and the angle affect the slope of the gradient (either steep or flat), and they also further affect the sedimentation behavior of the nanoparticles.

Dynamic light scattering (DLS) may be used to assess the size distribution of the DND particles in solutions. DLS is a widely used size determination technique that is quite sensitive to the concentration of sample solutions (Pecora, 2000). In support of DLS, analytical ultracentrifugation (AUC) (Planken & Colfen, 2010; Svedberg & Nichols, 1923)—a technique that provides high accuracy and resolution—can be used to examine the ultrafine composition of the size distribution of monodispersed primary particles that are collected. In AUC, an ultracentrifuge equipped with an optical detector is used to monitor the evolution of the sedimentation boundary of the colloidal dispersion under the application of a centrifugal field. The boundaries are modelled, after radial and time-invariant noise extraction, with finite-element solutions of the Lamm equation to obtain a two-dimensional (2D) distribution of the sedimentation constant and the diffusivity of the species present in the solution. This information could be converted to a hydrodynamic Stokes size distribution using the Svedberg equation:

$${d}_{H} = \sqrt{\frac{18 {η}_{s} s}{( {\overline{v}}_{p}^{- 1} - {ρ}_{s} )}}$$

Several previously published works (Planken & Colfen, 2010; Carney, et al., 2011; Harkness, et al., 2012; Lees, et al., 2008; Colfen & Pauck, 1997; Jamison, et al., 2009) have demonstrated the unprecedented effectiveness and accuracy, unmatched by transmission electron microscopy (TEM) of DLS (Wholleben, 2012), of AUC at measuring the size distribution of nanoparticles. Despite the good agreement in mean sizes observed in TEM and AUC for each fraction, there may be obvious quantitative differences in the spread of the size distributions as measured by both methods. Those differences can be attributed to a number of distinctions between the observables used to deduce the size distributions in each technique. First, AUC measures the hydrodynamic diameter of the particle in the solution-state, assuming the validity of Stokes law for a sphere (Wohlleben, 2012; Bootz, et al., 2004). Solvent-particle interactions (e.g., hydration shells [Osawa, 2009]) may contribute to the hydrodynamic diameter. Moreover, DNDs are irregularly shaped and far from spherical. Second, TEM images are 2D projections of the nanoparticles on the grid; size histograms are hence statistical distributions of the projections. Although a sphere has equivalent projections in all directions, an irregular geometric 3D shape would have enumerably different projections. Even a monodispersed, irregularly shaped nanoparticle system would appear to be polydispersed in size while viewed under the TEM. By comparing the DLS and AUC results, it was found that the size distributions measured by DLS have smaller mean diameters than those measured by AUC. It was also found that the perceived size by DLS is significantly influenced by the nanoparticle concentration. Meanwhile, DLS remains a useful tool to rapidly assess and compare the mean size of nanoparticle distributions, provided that the samples in question have similar concentrations.

It should also be noted that the particle size obtained via DLS is the equivalent Stokes diameter deduced from the diffusivity of the scattering species in the liquid (Berne & Pecora, 2000). On the other hand, fractionation by RZDGU is governed by the sedimentation rate of the particles (which is sensitive to their density, molecular weight, and diffusivity [Planken & Colfen, 2010]). Two particles could have a similar diffusion coefficient, yet they may sediment at substantially different rates.

A highly concentrated starting dispersion is desirable to increase the yield of the separation process, but there is often a trade-off between the concentration and the resolution of the size separation. Excessively high concentrations may cause particles to aggregate and interact or even become unstable during sedimentation, thus degrading the resolution.

High-pressure high-temperature (HPHT) diamond is another type of widely studied and most attractive synthesized diamonds because nitrogen doping enriched commercial micron-sized diamonds can be readily transformed into particles with fluorescent nitrogen-vacancy (NV) centers through ion irradiation and annealing (Boudou, et al., 2009). This kind of fluorescent centers are thermally stable and resistant to photo bleaching with long emission and spin-coherence time, which enable HPHT diamonds suitable for many novel applications in sensing (Mamin, et al., 2013), super-resolution microscopy (Maurer, et al., 2010), bio-labeling (Barnard, 2009), magnetometry (Balasubramanian, et al., 2008) and quantum computation (Neumann, et al., 2010). Commercially available micron-sized HPHT diamonds can be further mechanically milled to nano-size range on a large scale (Boudou, et al., 2009). But poly-dispersity of both particle size and NV center density is an obstacle for the application of milled HPHT nanodiamonds with NV centers. For example, quantum computation requires the controllable yield of photons for specific sites, that's to say a controllable number of fluorescent centers. On the other aspect, studies have shown that the density of fluorescent centers is strongly and inversely correlated with the size of the crystal (Rabeau, et al., 2007; Bradac, et al., 2009), which means that indirect control of the fluorescent center density can be achieved by direct control of diamond crystal size.

Diamond NV color centers can be formed when a substitutional nitrogen lodges itself in the carbon lattice, replacing two carbons and creating a physical vacancy with dangling bonds. Diamond NV centers can occur naturally or can be implanted in a diamond structure via ion radiation or the like. There are two charge states of this defect center, neutral NV⁰ and negative NV⁻. The NV⁰ has one unpaired electron. The NV-center has an additional electron associated with it, creating a desirable electronic S=1 structure that has a long-lived spin triplet in its ground state that can be probed using optical and microwave excitation. The NV electron spin can act as a sensitive probe of the local environment, and their optical accessibility can allow their use in optically-detected magnetic resonance schemes.

Here, the inventors applied the fractionation technique to separate milled micron-sized HPHT diamonds in size-controlled fractions. In recent published research (Mahfouz, et al., 2013), the inventors proved that the fractionated nanodiamonds could be converted to fluorescent particles through helium-ion irradiating a spin-coated monolayer of each nanodiamond fraction. The inventors also confirmed a strong inverse relationship between the particle size and the average number of NV centers per crystal, which is in good agreement with previous studies. Significantly, the results suggest large-scale size selection of nanocrystals provides a method to control the number of defects per nanocrystal, which is useful to researchers in the diamond community and, what's more, suggests the potential industry-scale production of diamonds with controlled NV center numbers.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

### Preparation of Highly Concentrated and Stable Solutions of DNDs

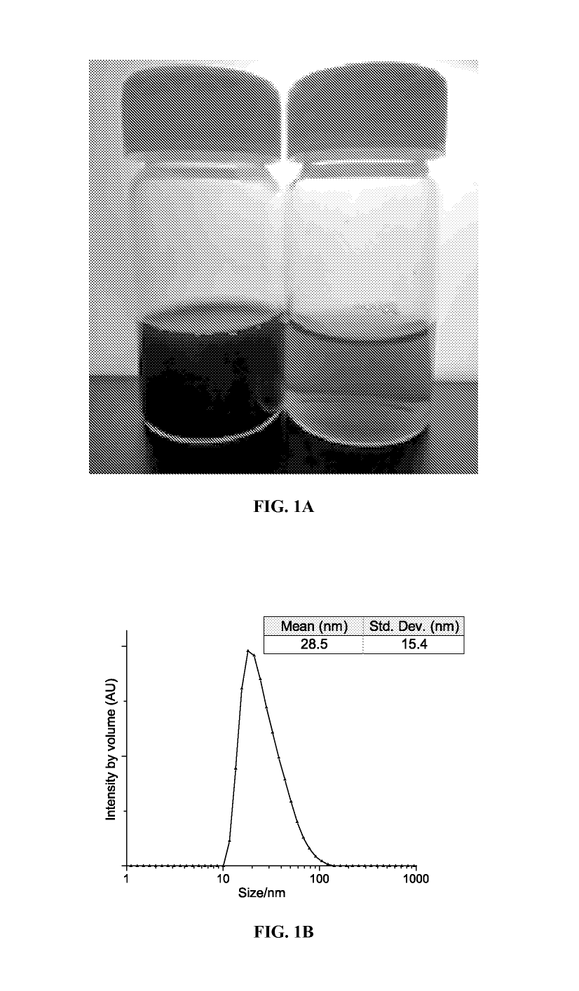

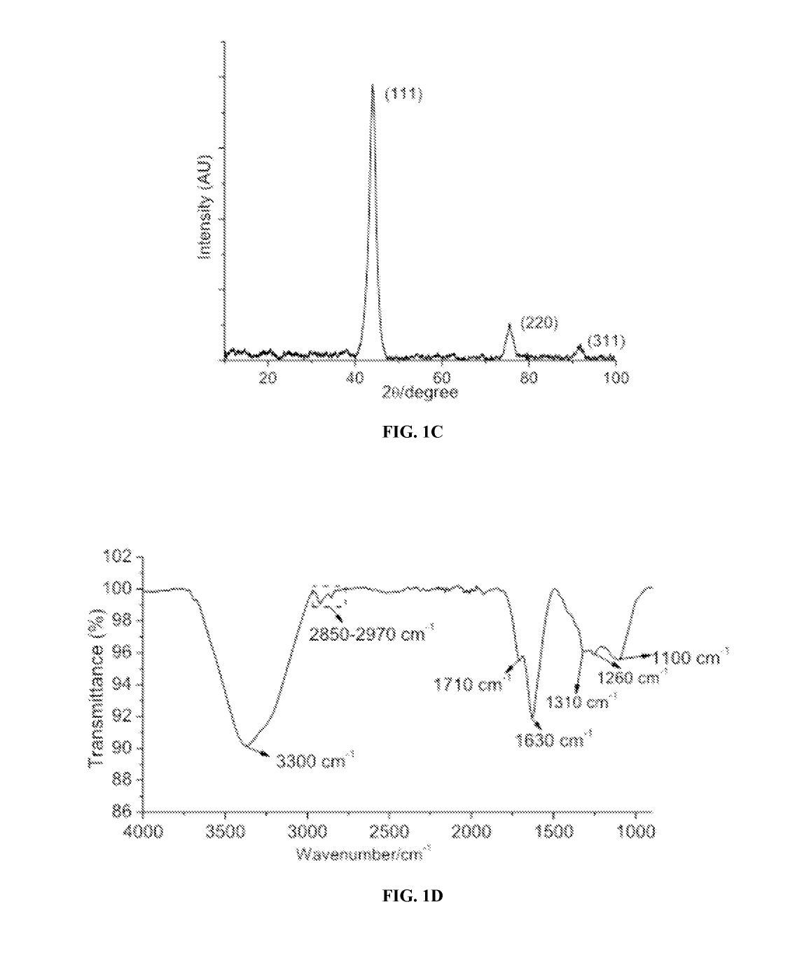

Preparing stable dispersions of nanoparticles is helpful for separating them by RZDGU. Here, the salt-assisted dry ball-milling method, which was proposed by Pentecost and co-workers (Pentecost, et al., 2010), was used to disintegrate the as-received pristine DNDs (pDNDs). This method has been shown to be efficient in reducing the size of DND aggregates, with the advantage that all possible milling contaminants can then be removed by acid treatment and rinsing. Although most of the resulting milled pDNDs (mpDNDs) were well dispersed in water by the end of the process, some precipitation was still observed, suggesting the incomplete disintegration of large aggregates. Therefore, this process was combined with additional subsequent ultrasonication to break apart remaining large aggregates, and a stable solution of highly concentrated DNDs (˜40 mg/mL) was obtained without observable precipitation. The colors of the solutions varied by concentration, from transparent brown for diluted dispersions to dark black for highly concentrated ones (see FIG. 1A) (Ozawa, et al., 2007).

The most suitable pH to disperse mpDNDs in water was determined by tuning the pH with HCl and NaOH aqueous solutions and observing whether the solution became turbid after standing still for 1 hour. It was found that when the pH was ˜3.8-4.0, the solution had the best dispersion. The zeta potential of the solution at pH˜3.8 was ˜40 mV, confirming the stability of the solution.

Dynamic light scattering (DLS) was used to assess the size distribution of the DND particles in solutions. FIG. 1B presents the size distribution of mpDNDs as determined by DLS. This DLS size distribution was compared with the DLS size distribution of a commonly used commercially available DND dispersion known as NanoAmando (Shenderova & Hens, 2010). The mpDNDs had a comparable size distribution to that of NanoAmando particles (See FIG. 11). The solution of mpDNDs with a concentration of 40 mg/mL could be stored under ambient conditions for over one month with very few precipitates forming.

The X-ray diffraction (XRD) spectrum of mpDND powder is shown in FIG. 1C. Peaks at 2⊖=44.0°, 75.7° and 91.6° can be observed. Those peaks were assigned to the (111), (220) and (311) crystal planes of diamond (Liang, et al., 2011; Xu, et al., 2005). No additional peaks were observed, suggesting the absence of crystalline impurities in the mpDNDs. Using Scherrer's formula (Klug & Alexander, 1974), the average core crystal size pertaining to individual nanodiamonds was estimated from the full width at half maximum (FWHM) of the (111) peak in the mpDNDs to be 3.7 nm.

FIG. 1D shows the Fourier transform infrared (FTIR) spectrum of the mpDND powder. The most important peaks are marked in the graph. The broad peak at 3300 cm⁻¹ is often attributed to the stretching vibration mode of absorbed water on nanodiamond surfaces (Jiang & Xu, 1995). The peak at 1630 cm⁻¹ has commonly been assigned to the bending vibration mode of adsorbed water (Mochalin, et al., 2008; Jiang & Xu, 1995). Adsorbed water molecules could not be completely removed even when the DNDs were dried in a vacuum oven at 120° C. for 1 day. The three weak peaks between 2850-2970 cm⁻¹ can be attributed to —CHₓ groups (where x can be 1, 2 or 3) (Larionova, et al., 2006). The ketone group is believed to be the source of the peak at 1710 cm⁻¹ (Butenko, et al., 2006). The origin of the peaks located between 1100-1370 cm⁻¹ has been attributed to ethers, acid anhydrides, lactones or epoxy groups (Jiang & Xu, 1995; Shenderova, et al., 2011). Specifically, the peak at around 1310 cm⁻¹ has been assigned to the bending vibration of C—H (Larionova, et al., 2006; Jiang & Xu, 1995), while hydroxyl bending vibration has been found to be related to the peak at around 1100 cm' (Jiang & Xu, 1995; Girard, et al., 2010). Overall, it was determined that the mpDNDs contain various functional groups containing hydrogen and oxygen.

### EXAMPLE 2

### Fractionation of DNDs through RXDGU

The process of preparing the density gradient and fractionating the particles in the RZDGU method is illustrated in FIG. 2. Two solutions of different concentrations of sucrose were layered in the centrifugation tube consecutively (light top, heavy bottom). A continuous density gradient formed while the tube was tilted at a specific angle and rotated at a predetermined angular velocity and length of time. Sample solutions were then layered on top of the as-prepared gradient and centrifuged to form a nanoparticle sedimentation profile along the length of the tube. Nanoparticles with different sedimentation coefficients reached different positions and were then collected separately. The inventors used a custom-built fractionator (see Experimental Methods) that simultaneously collected fractions of six identically processed sample tubes, which largely increased the process capacity and reproducibility. This fractionation procedure, including the density gradient preparation, sample loading, centrifugation and fraction collection took around two hours, including the variable centrifugation time.

A two-iteration fractionation procedure was performed on the mpDND solution. The two iterations were performed under different centrifugation conditions, as shown in FIG. 3, and with the same gradient medium but varied gradient slopes. A continuous band of nanodiamonds was observable and it was divided into several fractions, which were then collected (each fraction was consecutively numbered; fractions collected in the first iteration were denoted as F′; fractions collected in the second iteration were denoted as F″). After extracting the sucrose by dialysis, each fraction was redispersed in aqueous HCl solution (pH˜3.8) and stored until further characterization.

The concentration was optimized at ˜40 mg/mL before any undesired sedimentation behaviour was visually discernable.

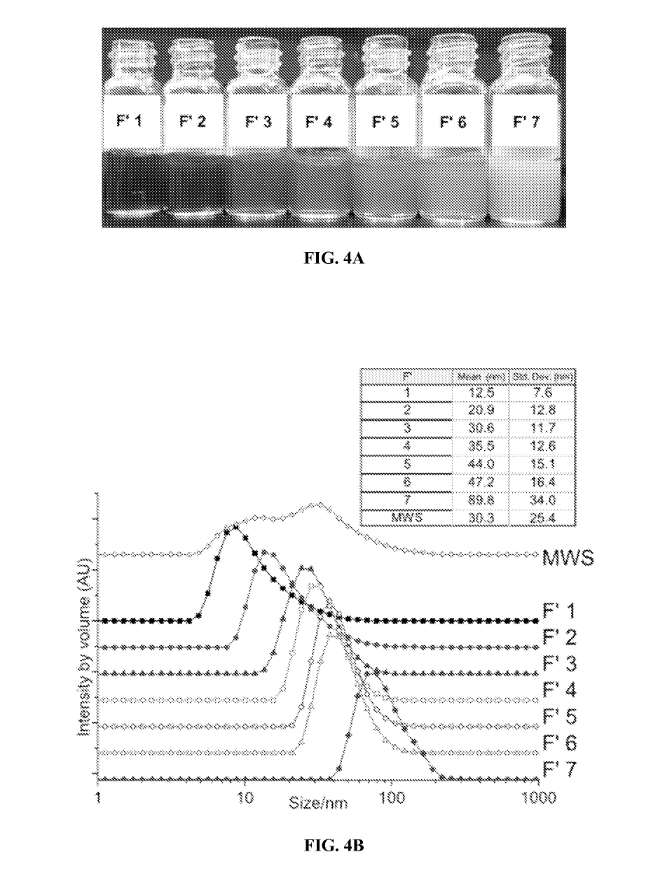

In the first iteration, seven fractions were collected (including the precipitate at the bottom of the tube, see FIG. 3). A photograph of the seven collected fractions is presented in FIG. 4A. The colours of these solutions vary from transparent deep brown to opaque milky white. This optical phenomenon is consistent with the Rayleigh scattering of light by the DNDs in solution, whose intensity increased according to particle size (Ozawa, et al., 2007). FIG. 4B presents the size distributions of each fraction as determined by DLS. Significant fluctuations were observed in the size distributions measured by DLS depending on particle concentration, and the concentrations of all fractions were adjusted to be approximately equal before measuring them by DLS, thus ensuring a fair comparison between particle sizes of different fractions. The average particle size in each fraction increased from 12.5 nm in F′ 1 to 89.8 nm of F′ 7. See Table 1.

TABLE 1

| F′ | Mean (nm) | Std. Dev. (nm) |
|---|---|---|
| 1 | 12.5 | 7.6 |
| 2 | 20.9 | 12.8 |
| 3 | 30.6 | 11.7 |
| 4 | 35.5 | 12.6 |
| 5 | 44.0 | 15.1 |
| 6 | 47.2 | 16.4 |
| 7 | 89.8 | 34.0 |
| MWS | 30.3 | 25.4 |

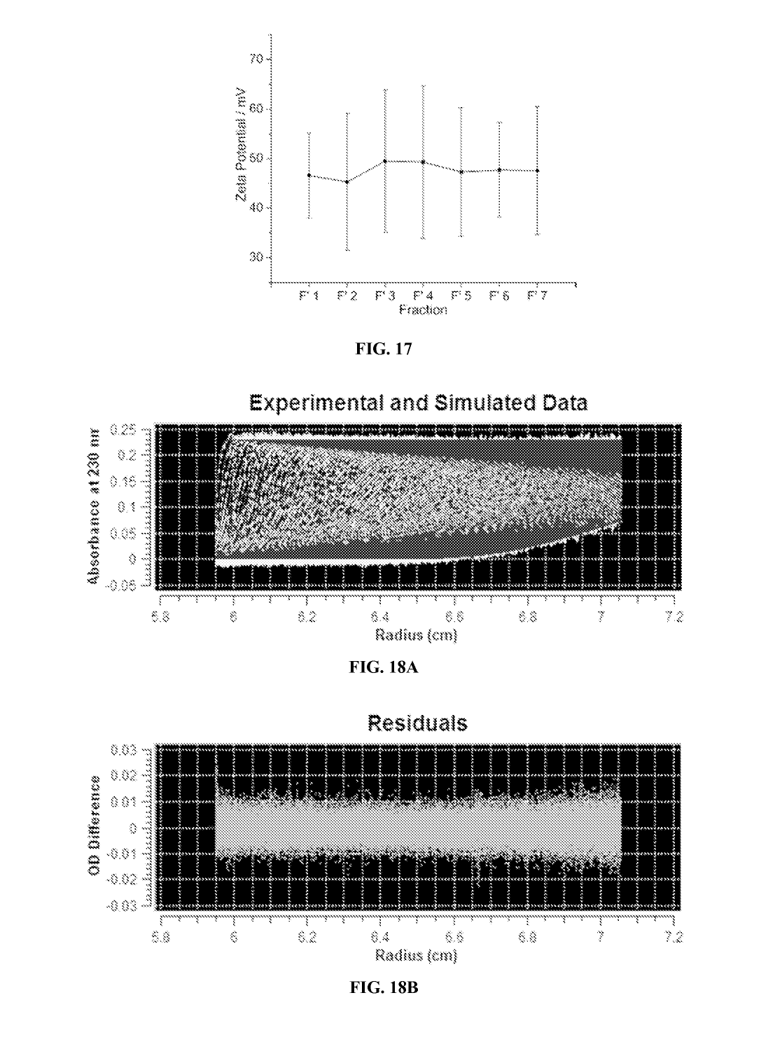

To assess the colloidal stability of DNDs in different fractions, their Zeta potentials were measured (FIG. 17). All the values are in the range from 45 to 50 mV, which suggests that the DNDs from each fraction were very stable (Gibson, et al., 2009).

The materials in each fraction were dried and weighed. Table 2 presents the mass and the mass percentage of each fraction. F′ 1 accounted for about 30 wt % of the sample, which contained most of the primary particles. An accurate size distribution of the pre-fractionated mpDNDs were reconstructed by summing the size distributions of each fraction weight by their respective mass percentage (i.e., mass-weighted sum, MWS, FIG. 4). The average size of DNDs measured directly by DLS (28.5 nm, FIG. 1) is in good agreement with the one obtained from the MWS distribution (30.3 nm, FIG. 4). Nevertheless, the reconstructed MWS distribution revealed the bimodal nature of the size distribution of the mpDNDs, which suggests that coupling RZDGU fractionation with DLS helps to improve the resolution of the DLS size measurement.

TABLE 2
Mass of F′ 1-7 and corresponding mass
fraction (in %) relative to the overall sample

| F′ | 1 | 2 | 3 | 4 | 5 | 6 | 7 | Total |
|---|---|---|---|---|---|---|---|---|
| Mass (mg) | 124.0 | 86.7 | 61.1 | 45.6 | 34.0 | 24.5 | 31.5 | 407.4 |
| Percentage (%) | 30.4 | 21.3 | 15.0 | 11.2 | 8.4 | 6.0 | 7.7 | 100 |

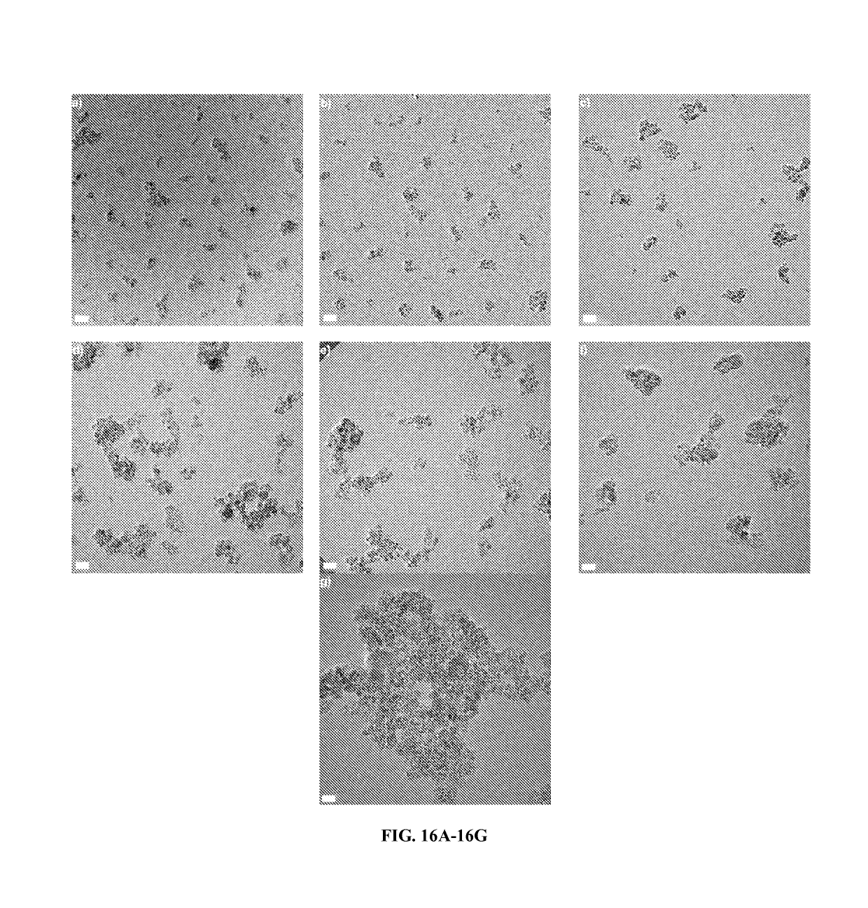

Although TEM does not provide exact information about the size distribution of DND aggregates in solution due to drying artifacts, it was observed that the size of the aggregates in solutions deposited from each fraction on TEM grids progressively increased with fraction number (FIG. 16). Although qualitative, this trend is consistent with the DLS size distributions presented in FIG. 4B.

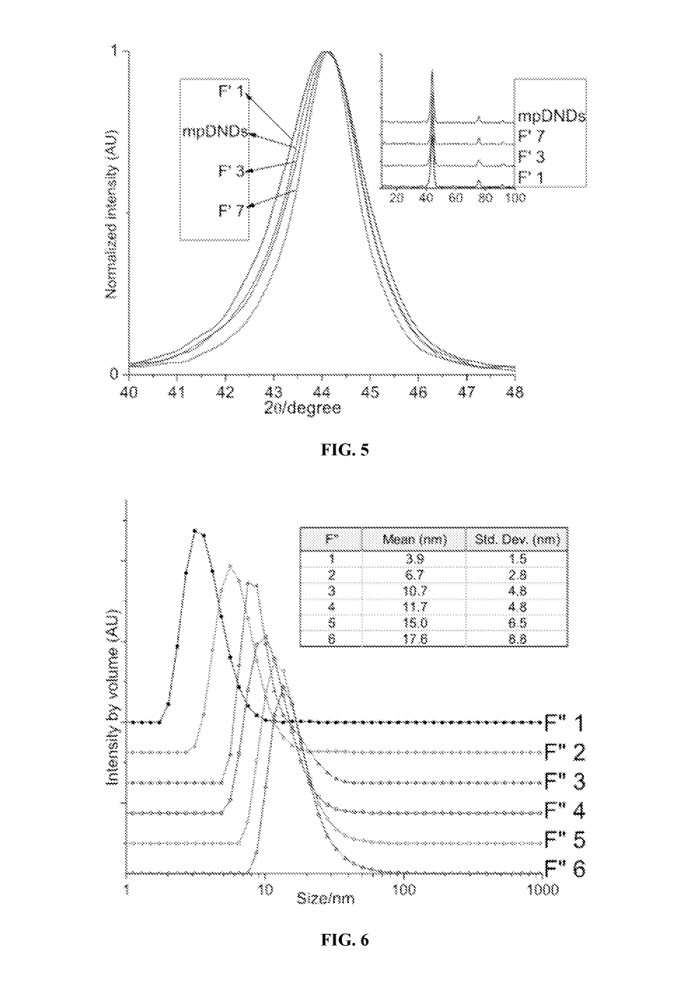

A comparison of the XRD spectra of F′ 1, 3 and 7 unexpectedly revealed a significant trend in the size of the crystals that comprised the varying sizes of DND aggregates (see FIG. 5). The FWHM of the (111) peak indicated that the crystal size increased with the fraction number. Using Scherrer's formula, the average crystal sizes in F′ 1, 3 and 7 were estimated to be 3.3 nm, 4.0 nm and 4.4 nm, respectively. The average size of the pre-fractionated raw DND crystals was 3.7 nm. This observation suggests that larger aggregates are comprised of larger primary particles.

Since the materials in F′ 1 accounted for 30 wt % of the total, it was possible to collect enough DNDs from F′ 1 for a second iteration of fractionation. In an effort to extract only primary particles in the second iteration, the first six fractions were collected near the top of the gradient as illustrated in FIG. 3. The size distributions of these six layers measured by DLS are shown in FIG. 6. The inset table gives the mean sizes and standard deviations of each fraction. The sizes of the nanodiamonds in F″ 1 were smaller than 10 nm, suggesting that they were mostly primary particles. By utilizing a two-iteration fractionation process, it was possible to extract monodispersed fractions far more accurately than a single iteration separation could afford. Focusing on a single-size-range fraction of interest enables the optimization of the density gradient, centrifugation time, and the entire length of the tube specifically for the range of interest, without the need to accommodate other particle sizes present in the original material.

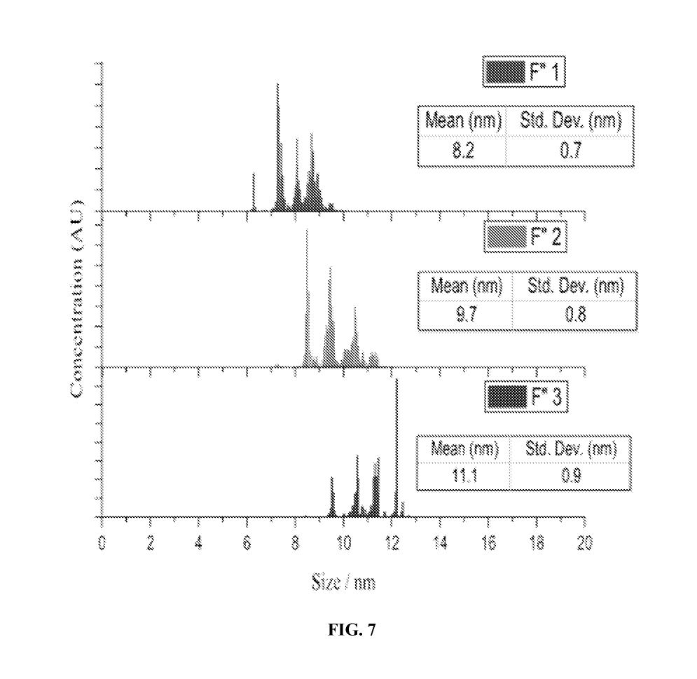

AUC was used to examine the ultrafine composition of the size distribution of monodispersed primary particles that were collected in the second iteration. FIG. 7 presents the hydrodynamic diameter distributions of the first three fractions in the second iteration. All three fractions have a very narrow size spread and mean diameters that differ by about 1-2 nm, confirming the efficiency of the separation process.

Perhaps the most striking features of FIG. 7 are the sharp peaks in each fraction. Moreover, the peaks occur at consistently similar positions within different fractions (although with different ratios). For example, peaks occur at ˜8.6 nm in F″ 1 and F″ 2; at ˜9.4 nm in F″ 1, F″ 2, and F″ 3; and at ˜10.5 nm along with ˜11.2 nm in F″ 2 and F″ 3. The narrowness of the peaks and their reasonably close registry from fraction to fraction suggests the presence of distinct species of primary DND particles in solution that occur in different abundance ratios within each of the three fractions shown in FIG. 7.

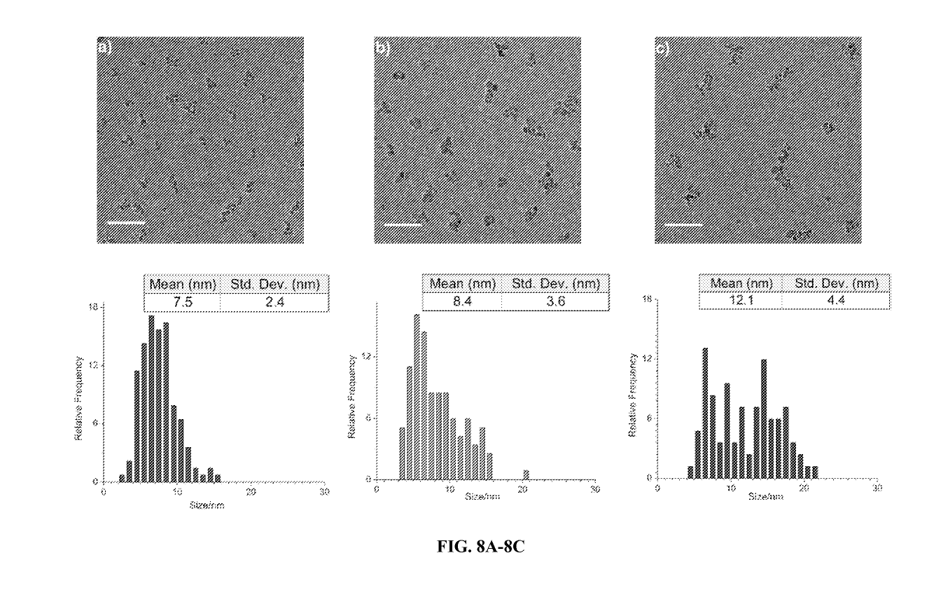

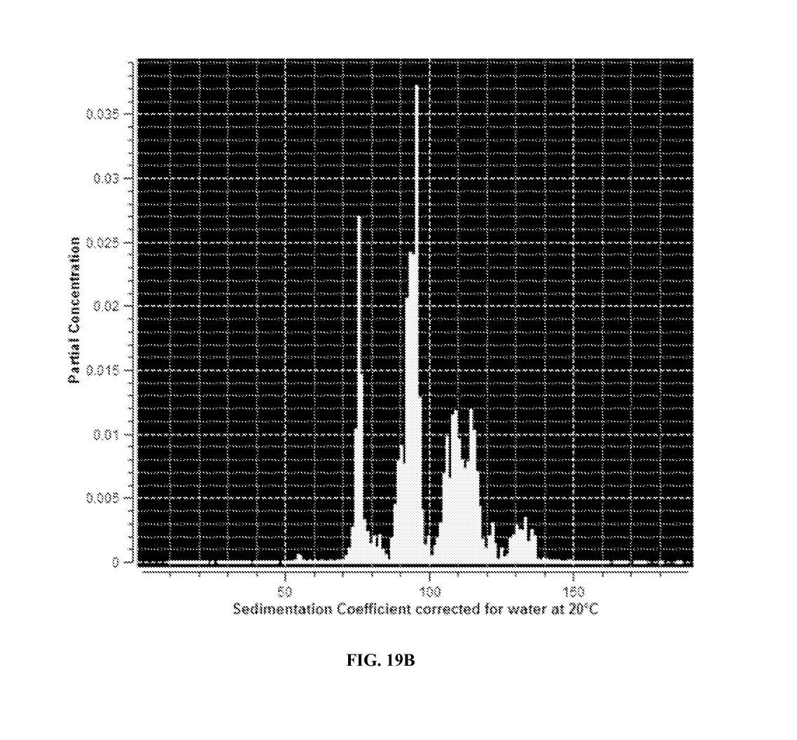

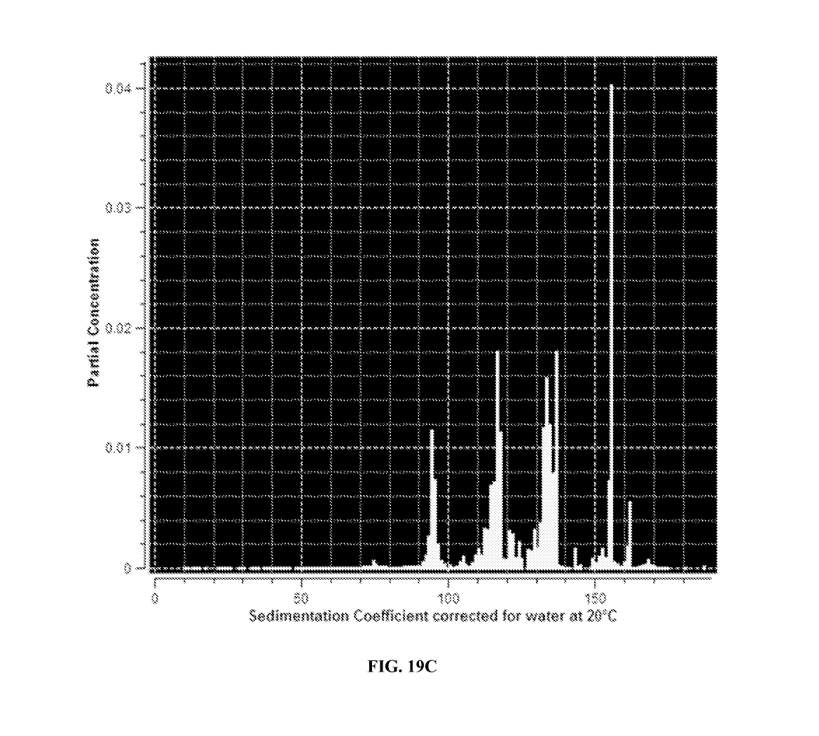

TEM images of F″ 1, F″ 2, and F″ 3 are presented in FIG. 8. The uniformity of the particles in these three fractions is considerably superior to that of any other fraction collected in the first iteration (see FIG. 16). A statistical analysis was performed on the size distributions of particles in F″ 1, F″ 2, and F″ 3 (see FIG. 8) by measuring the apparent area of each particle and calculating the diameter of an equivalent circle. The size distributions of the particles are in very good agreement with the average sizes measured by AUC (FIG. 7) for each fraction. Moreover, there is qualitative agreement between the TEM and AUC observations on one side, and DLS (FIG. 6) measurements on the other, since F″ 1<F″ 2<F″ 3. However, despite the good agreement in mean sizes observed in TEM and AUC for each fraction, there are obvious quantitative differences in the spread of the size distributions as measured by both methods (see FIG. 19).

### EXAMPLE 3

### Comparison of Different Centrifugal Fractionation Techniques

Operation time cannot be used to compare the efficiency of different techniques in different nanoparticle systems because the centrifugation time, included in the operation time, varies with the sedimentation coefficients of nanoparticles in solution. See Table 3. However, from the table, it can be seen that for DND systems, RZDGU is a more efficient method than multi-step centrifugation.

TABLE 3
Comparison of different centrifugal fractionation techniques

| | | Step-wise gradient | Multi-step | Continuous gradient |
|---|---|---|---|---|
| | IPDGU | RZDGU | centrifugation | RZDGU |
| | (carbon nanotubes)^{1,2} | (FeCo@C)³ | (DNDs)⁴ | (DNDs) |
| Processing | ~0.1-1 mg | ≦2 mg | ~20 mg | ~400 mg |
| capacity | (Can be increased | | | |
| | by concentrating the | | | |
| | raw solution and | | | |
| | employing large- | | | |
| | volume, industrial | | | |
| | centrifuges) | | | |
| Operation | ≧12 h | ≧3 h | ≧8 h for 5 | ≦2 h |
| time^{a} | (long centrifugation | | fractions (the time | |
| | time) | | increases | |
| | | | proportionally to | |
| | | | the number of | |
| | | | fractions) | |
| Size- | High | Intermediate | Low | Intermediate |
| separation | (<1 nm depending | (~2 nm for | (large overlap | (≦10 nm for starting |
| resolution^{b} | on density | nanoparticles with | occurs between | materials with a size |
| | differences) | a size range of 2-12 nm) | multiples | rage of over 100 nm; |
| | | | fractions; | improved to <2 nm |
| | | | resolution not | while at a small |
| | | | reported) | starting size range |
| | | | | ~40 nm) |
| Applicability | colloidal materials | any colloidal | any colloidal | any colloidal |
| | with low density | materials | materials | materials |
| Scalability | difficult to scale in | difficult to scale | scalability | Large scalability |
| | lab | due to the tedious | inversely | |
| | | preparation and | proportional to the | |
| | | little reproducibility | number of | |
| | | of gradients | fractions | |

### EXAMPLE 4

### Size Determination by DLS

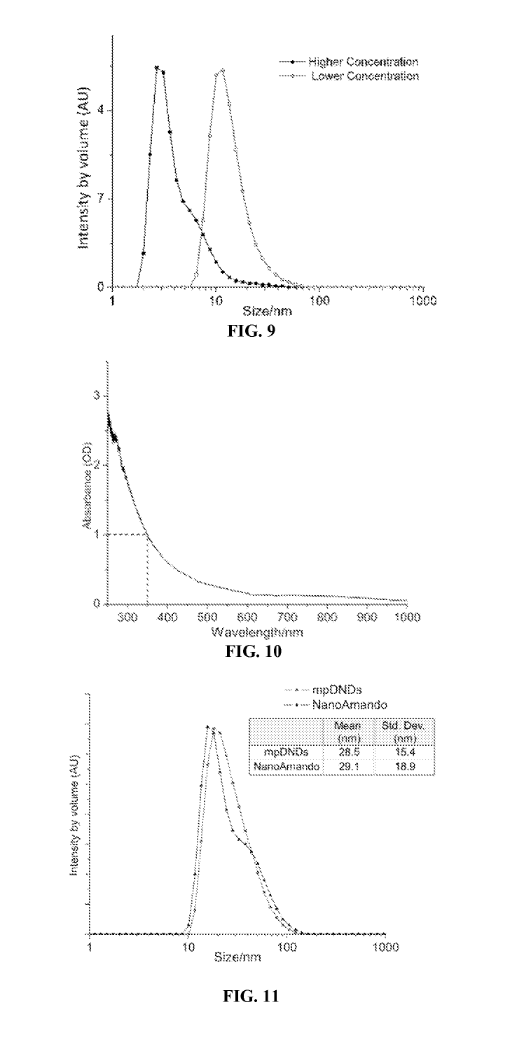

DLS is a widely used size determination technique that is quite sensitive to the concentration of sample solutions (Pecora, 2000). This was confirmed by measuring the mpDNDs in aqueous solutions at a high and a low concentration comparably (the one with the lower concentration was obtained through diluting the higher one with HCl solution, pH˜3.8), as shown in FIG. 9. Controlling the concentration became quite important to compare the size distributions of the particles fairly in different samples and fractions. Considering the direct relationship between the concentration and the optical absorbance, the optical absorbance of the sample solution was tuned at the wavelength of 350 nm to optical density (OD) ˜1.0 by diluting the original sample solution (loaded in a quartz vile) before each DLS measurement, as shown in FIG. 10. This pre-controlling procedure also enabled a comparison of the solution of the mpDNDs with other commercial products of DND suspensions. FIG. 11 is the DLS graph of the mpDNDs and a commercial product named NanoAmando (NanoCarbon Research Institute, Ltd., Japan), which shows that the mpDNDs also have a good dispersion state.

### EXAMPLE 5

### Optimization of RZDGU Conditions

20-60 wt % sucrose aqueous solutions were used to prepare the continuous density gradient through tilt tube rotation using a gradient station. A 20 wt % sucrose solution was first laid in the bottom of the centrifuge tube up to the 45% level, with a 12 mL Norm-Ject syringe (Henke Sass Wolf) and a Vita 14 steel needle, and then a 60 wt % sucrose solution of the same volume was injected to the bottom slowly to ensure a sharp interface between the two solutions. Continuous density gradients were obtained through tilted tube rotation using a gradient station with built-in programs. Then, 1.6 mL of previously prepared DND solution was laid on the top of the as-prepared gradient solution with a 1.0 mL BD syringe (Becton, Dickinson and Company) and a disposable Pasteur pipette (Fisher Scientific) and balanced before being placed in the ultracentrifuge. The centrifugation conditions for two iteration fractionations varied: 20,000 rpm/50 min for the first iteration and 30,000 rpm/75 min for the second one. Fractions in the gradient containing nanodiamonds were then collected with a 6-piston gradient fractionator. The obtained fractions were further rinsed by dialysis with an HCl aqueous solution (pH˜3.8) using molecular centrifugal filters (15 mL, Amicon® Ultra-15). By using centrifugal filters instead of ultracentrifugation to rinse the sample, the re-aggregation phenomenon could largely be avoided.

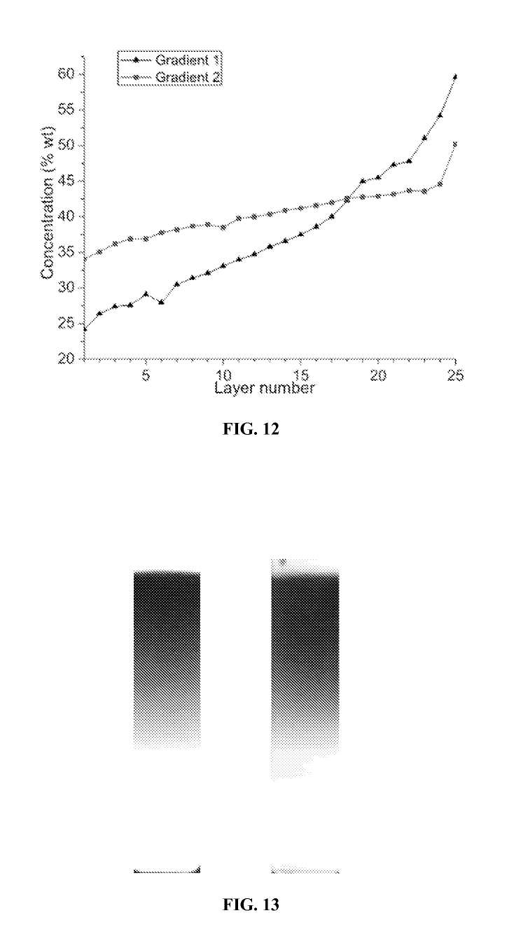

Two gradient-making programs were studied: Program 1: first step: rotation time 9 min 30 s and tilt angle 50°; second step: rotation time 40 s and tilt angle 80°; Program 2: first step: rotation time 9 min 30 s and tilt angle 60°; second step: rotation time 40 s and tilt angle 80°. The gradients made by these two programs were called Gradient 1 and Gradient 2, respectively. To discover the profiles of the gradients, the gradients were separated into 25 layers of 2 mm each along the tube, and their densities were determined by a density meter (Density Meter, DMA 35). The gradients made with these two programs had unique characteristics in regard to their profiles but they were typical enough to study the influence of the gradient slope, as is shown in FIG. 12. These two gradients were then used to fractionate the mpDNDs. In the first experiment, the centrifugation condition was 20,000 rpm for 50 minutes. The photos of the resulting bands in the gradients are shown in FIG. 13. It is easy to see that the bands in Gradient 1 are broader than those in Gradient 2. This is because a larger tilt angle would result in a flat gradient but with a higher density and viscosity near the top of the gradient, which would slow down the sedimentation speed of the nanoparticles and therefore narrow the bands. Considering that an increase in the length of the band in the gradient would result in an increase in the resolution of the fractionation, the inventors chose gradient 1 for the first fractionation. Of course, the bands could be broadened by using sucrose solutions with lower concentrations, e.g., 10-50 wt %, but this would also decrease the ability of the gradient to prevent diffusion behavior and vortex motion due to a decrease in the viscosity and density along the whole tube.

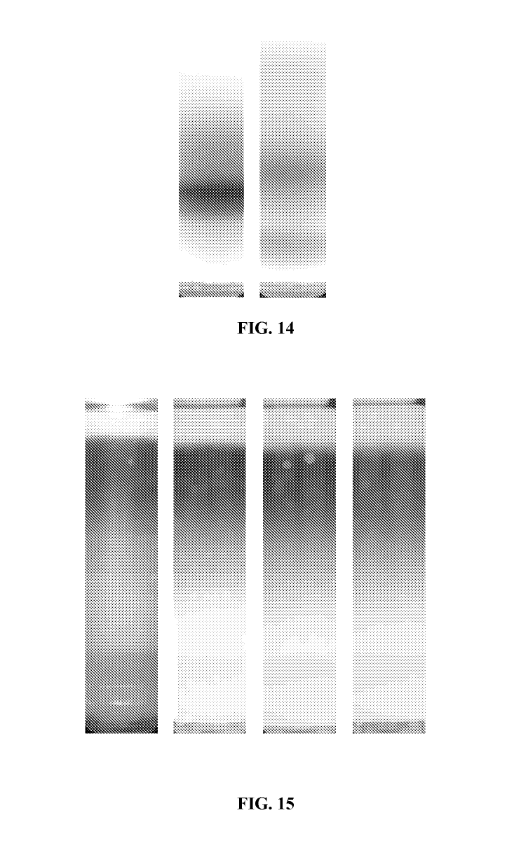

For the second iteration of fractionation, the case was different. The mixtures obtained in the first experiment were centrifuged at 30,000 rpm for 1 h in a subsequent step. Photos taken after the subsequent centrifugation are shown in FIG. 14. As expected, the smallest nanoparticles at the top of the gradient moved slower in Gradient 2 than in Gradient 1.

In the following experiment, the centrifugation conditions were optimized for the second iteration of fractionation to stretch the bands and therefore increase the resolution of the fractionation. Different centrifugation times of 1 h, 1.25 h, 1.5 h and 1.75 h at the speed 30,000 rpm were applied to the fractionation of the first fraction from the first fractionation. The photos are shown in FIG. 15. It is easy to see that the top of the bands moved downward as the centrifugation time increased, whereas the broadness of the bands first increased when the centrifugation time increased from 1 h to 1.25 h and then remained mostly the same, which can be interpreted as increasing hindrance from the gradient compensating for the increased centrifugal force with nanoparticles moving deeper in the gradient.

After well-designed contrast experiments, the inventors chose Gradient 1 with centrifugation conditions of 20,000 rpm for 50 min for the first fractionation procedure and Gradient 2 with centrifugation conditions of 30,000 rpm for 1.25 h for the second iteration.

### EXAMPLE 6

### TEM

TEM images of the 7 fractions collected in the first iteration of the fractionation procedure are shown in FIG. 16.

### EXAMPLE 7

### AUC Analysis

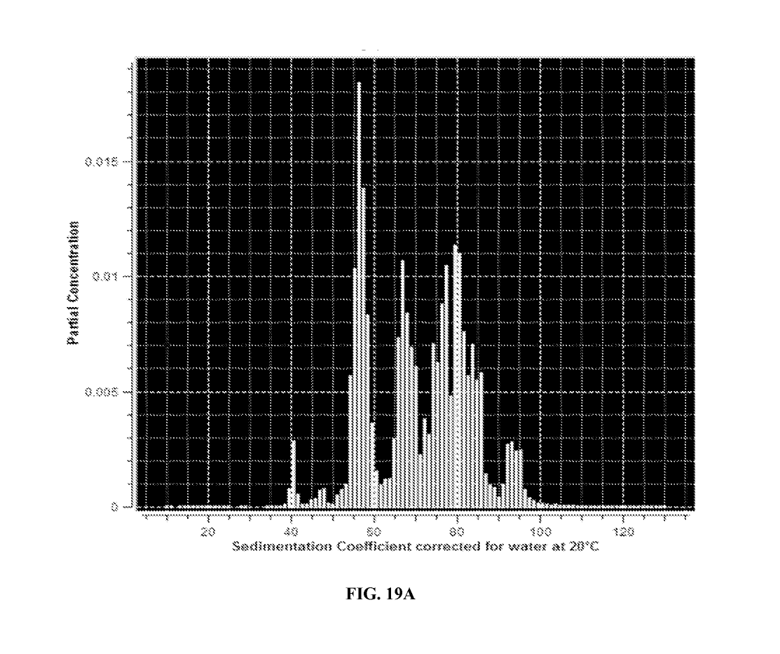

FIG. 18 shows an example of how the sedimentation coefficient distributions (FIG. 19) were obtained from AUC by analyzing the sedimentation boundaries with Ultrascan III (Demeler, et al., 2012). The noise subtraction was performed by two-dimensional spectrum analysis (2DSA) (Brookes, et al., 2010) with meniscus optimization (Demeler, et al., 2010).

The experimental (light grey) and simulated (dark grey) sedimentation boundaries of F″ 1 and the corresponding residuals are presented to demonstrate the good match between the simulated model and the raw sedimentation data in FIG. 18.

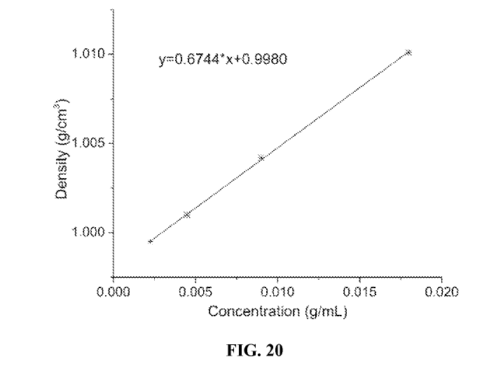

The sedimentation distributions (FIG. 19) were obtained after optimization with Monte Carlo analysis (Demeler & Brookes, 2008) with 100 runs. The size distributions shown in FIG. 7 were obtained from FIG. 19 using the Svedberg relation:

$${d}_{H} = \sqrt{\frac{18 {η}_{s} s}{( {\overline{v}}_{p}^{- 1} - {ρ}_{s} )}}$$

where d_{H} is the hydrodynamic diameter or size; s is the sedimentation coefficient; ρₛ and ηₛ are the solvent density and viscosity, respectively; ν̅ₚ is the partial specific volume, which was experimentally measured (see next example and FIG. 20).

### EXAMPLE 8

### Determination of the Partial Specific Volume of MPDNDs

The average density of mpDNDs was taken as the inverse of the partial specific volume and was measured by obtaining the linear relation between the density and the concentration of the clear mpDND solution (without precipitation) by linear fitting four sets of raw data (see FIG. 20) from which the slope could be then used in the Kratky relation (Kratky, et al., 1973) to calculate the partial specific volume. The partial specific volume of mpDNDs was calculated to be 0.326 cm³/g, and thus the particle density, which is the inverse of the partial specific volume, was 3.06 g/cm³. This density value is in good agreement with the literature for DNDs (Larionova, et al., 2006).

### EXAMPLE 9

### Experimental Methods

Materials and chemicals-DNDs with nominal primary particle sizes of less than 10 nm were sourced from Sigma Aldrich (catalogue # 636428-5G) and NanoCarbon Institute (NanoAmando). Unless stated otherwise, all fractionation studies were conducted on the DNDs from Sigma Aldrich. The water used was MilliQ (18 MΩ). All other reagents were ACS reagent grade and sourced from Sigma Aldrich.

DND solution preparation-Concentrated DND solutions were prepared according to the salt-milling method described by Pentecost et al., 2010. DNDs were mixed with sodium chloride in the ratio of 1:7, and then put in steal jars (50 ml in volume, Retsch Co., German), with 50 g stainless steel grinding balls each jar (0.6 cm in diameter). The milling procedure was carried out at 400 rpm for 15 h (1 h interval and 0.5 h break) in a Planetary Ball Mill PM 200 (also from Retsch). After milling, the mixture were then moved into centrifugation tubes (38 mL, Nalgene, Thermo Scientific) filled with hydrochloride acid (37% in volume), diluted with deionized water to remove iron contaminations from the balls and jars, and centrifuged in an ultracentrifuge (Superspin 610 rotor, WX Ultra 90, Thermo Scientific) to precipitate all the nanoparticles from the solvent. Collected nanodiamonds were then re-dispersed in deionized water and centrifuged again. This rinsing procedure was repeated for several times until negative test with 0.1N silver nitrate (volumetric standard, 1.0N in water, diluted with deionized water). Salt-milled and purified DNDs were dispersed in aqueous HCl solutions (pH˜3.8) and sonicated with an ultrasonic probe (φ1.27 cm Standard probe, Ultrasonic Processor Q500, maximum out-put power 400W, Qsonica) under the condition of 60% amplitude for 1.5 h.

Fractionation and Centrifugation-A customized gradient station and a six-piston fractionator manufactured by BioComp Instruments Inc. (Fredericton, NB, Canada) were used in the fractionation procedure for preparing density gradients and collecting fractions, correspondingly. Centrifugation was carried out in a Thermo Scientific ultracentrifuge (WX Ultra 90) using a Superspin 630 rotor and Nalgene tubes (38 mL, Thermo Scientific). A detailed description of the RZDGU procedure can be found in the Supporting Information.

Characterization-Dynamic light scattering (Zetasizer Nano ZS, Malvern) was used to measure the size distributions of the samples. The measured size distributions by DLS were found to be sensitive to the concentrations of particles in solutions (see FIG. 9). The concentration of each sample solution was controlled by tuning the absorbance of the sample to optical density (OD)˜1.0 at the wavelength of 350 nm (Ocean Optics Inc., light source DH-2000-Bal, 1 cm path-length cuvette) through dilution with an aqueous HCl solution (pH˜3.8) before each DLS measurement (See FIG. 10). A Lemis ViscoDens VDM-300 was used to measure the solvent viscosity and density of pH˜3.8 HCl solutions for DLS parameter set-up. These two parameters were also used in the AUC experiments. In each measurement, over 90 runs (20 seconds per run) were averaged to avoid environmental perturbation and obtain stable data. A Zetasizer was also used to measure the zeta potential of the DNDs in each sample solution.

The AUC experiments were carried out with a Beckman Optima XL-A (controlled by a PC running a Beckman Proteome Lab v5.8 acquisition software) equipped with an An-60 Ti rotor and an optical absorbance detector, with similar procedures as in the paper of Harkness et al., 2012. The concentration of the sample solutions (440 μL) was adjusted by diluting the sample solution with HCl aqueous solutions (pH˜3.8) until their optical absorbance at the wavelength of 231 nm was OD˜0.5 before being loaded into double-sector centrepieces with quartz windows. A reference nanoparticle-free aqueous HCl (pH˜3.8) solution was loaded in the sector adjacent to the sample solution. The samples were loaded in the rotor and left in the ultracentrifuge for about 5 hours until the temperature equilibrated at 20° C. Then, the ultracentrifuge was started up at a rotor speed of 12, 000 rpm. To acquire sedimentation profiles, the sectors were scanned in 0.003 cm radial increments and the average time required to scan an entire sector was about 1 minute. The inventors analysed approximately 130 sedimentation profiles for the subtraction of time-invariant and radial-invariant noise, meniscus optimization, and Lamm equation modelling using Ultrascan III (Demeler, et al., 2012) two-dimensional spectrum analysis (2DSA) (Brookes, et al., 2010; Demeler & Brookes, 2008). Sedimentation-diffusion distributions were then obtained after Monte Carlo analysis (100 runs) (Demeler & Brookes, 2008). Solvent densities and viscosities were obtained from the USLIMS Database, while the partial specific volume of the DNDs was measured to be 0.326 cm³/g using the Kratky method (Kratky, et al., 1973) (see FIG. 20).

A high-resolution transmission electron microscope (HRTEM; Titan G2 80-200, FEI Co.) was utilized to investigate the sizes and structures of the primary particles. Aqueous solutions of DNDs that were dried on 300 mesh Au grids (Ted Pella Inc., USA) were characterized with an acceleration voltage of 300 kV.

X-ray diffraction (XRD) (Broker D8 Advance, Cu λ_{Kα1}=1.5406 Å, increment 0.01 degree/step, scan speed 1 s/step) was used to study the phase purity of the post- and pre-separated DNDs. The solution of DNDs was dried in a freeze dryer (Labconco FreeZone −105° C., USA) to obtain powders for XRD characterization. The full width at half maximum (FWHM) of the (111) peak was obtained through Gaussian fitting. Dried powders were weighed for the calculation of the concentrations of the sample solutions as well.

Fourier transform infrared spectroscopy (FTIR) (Thermo Scientific, Smart iTR) was used to obtain insights into the surface functional groups of the mpDNDs (32 scans, resolution 2 cm⁻¹).

### EXAMPLE 10

### Production and Analysis of Fluorescent Nanodiamonds

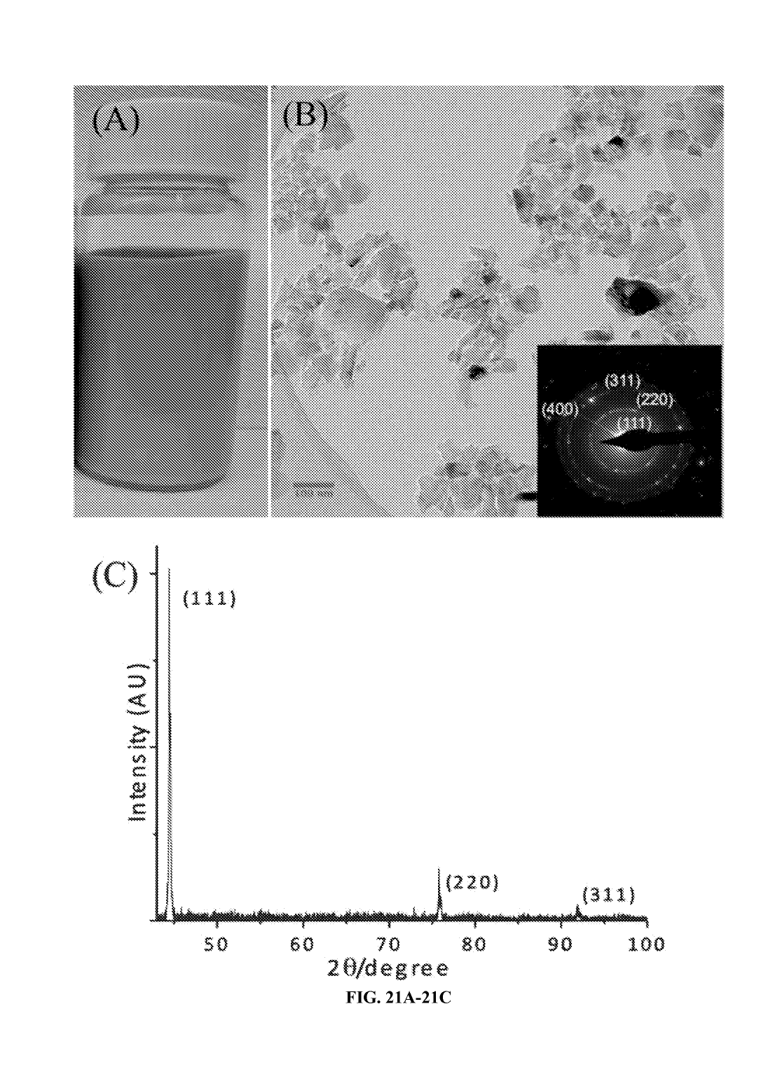

DNCs were prepared on a large scale by ball-milling micronsized synthetic HPHT diamond powder (210-250 mm) (Boudou, et al., 2009). The diamond powder was further milled with NaCl and then dispersed in water after additional purification. The purified DNCs in solution are shown in FIG. 21A. It is worth noting that DGU requires relatively stable colloidal solutions of nanomaterials (i.e., individually dispersed particles) to prevent aggregation, which would hinder the size separation.

Dried DNC samples were investigated by transmission electron microscopy (TEM), electron diffraction and X-ray diffraction (XRD). The microscopic investigations revealed that the samples consisted of highly faceted and irregularly shaped mono-crystalline DNCs less than 100 nm in size (FIG. 21B). Electron diffraction (inset, FIG. 21B) and XRD (FIG. 21C) studies of these powders indicated that the DNCs were only in the diamond cubic phase. To study the formation of luminescent NV centers as a function of nanocrystal size, it was necessary to separate the polydispersed milled product (as shown in the TEM image in FIG. 21B) into fractions of narrower size distributions. This method layers the nanoparticle dispersion on top of a specially prepared density gradient of 20% to 60% sucrose solutions.

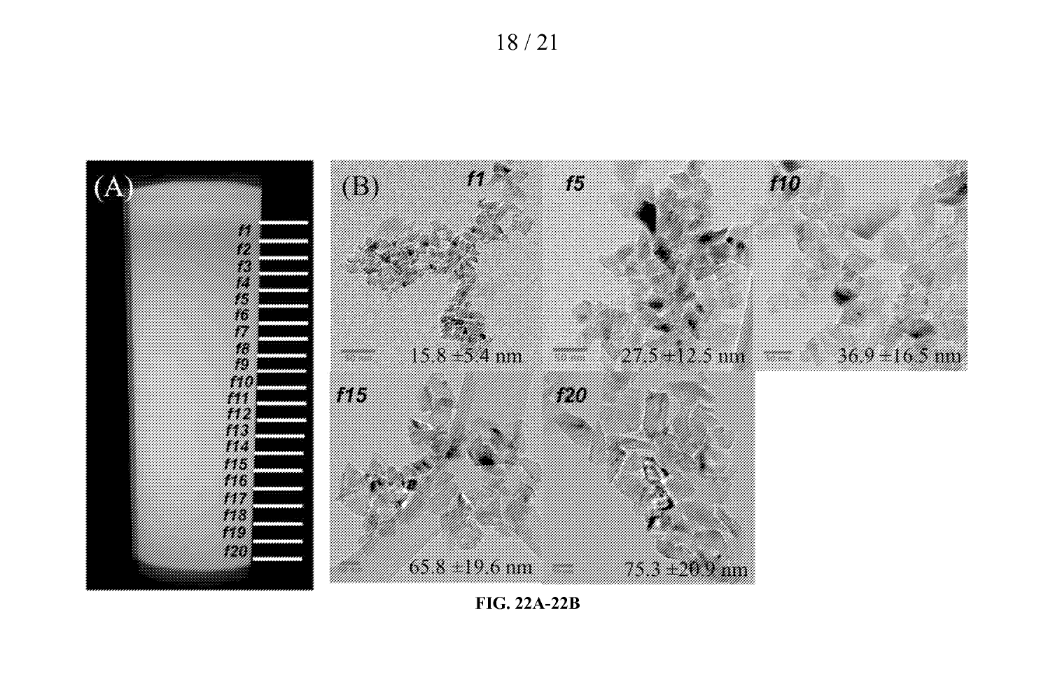

After layering on top of the gradient, the DNC dispersion was then subjected to centrifugation for enough time to allow the fastest sedimenting particles to traverse the centrifuge tube without reaching its bottom. Subsequently, the contents of the tube were collected into 20 fractions using a fractionator. An image of the DNCs gathered in the density gradient after centrifugation is presented in FIG. 22A. The inventors chose fractions f1, f5, f10, f15, and f20 as candidates for further defect creation studies by irradiation (vide infra). The choice was made based on the sizes of the particles in these fractions, which were representative of all crystal sizes present in the tube. TEM images of the DNCs in the five fractions are presented in FIG. 22B (the average sizes and standard deviations of the DNCs in the images are marked correspondingly). The statistical data of these five fractions clearly indicated good size separation, considering the fact that RZDGU fractionation depends on the sedimentation coefficients of nanoparticles whereas size measurement by TEM depends on 2D projections of nanoparticles (Peng, et al., 2013). These five fractions were subsequently used in irradiation and optical characterization experiments.

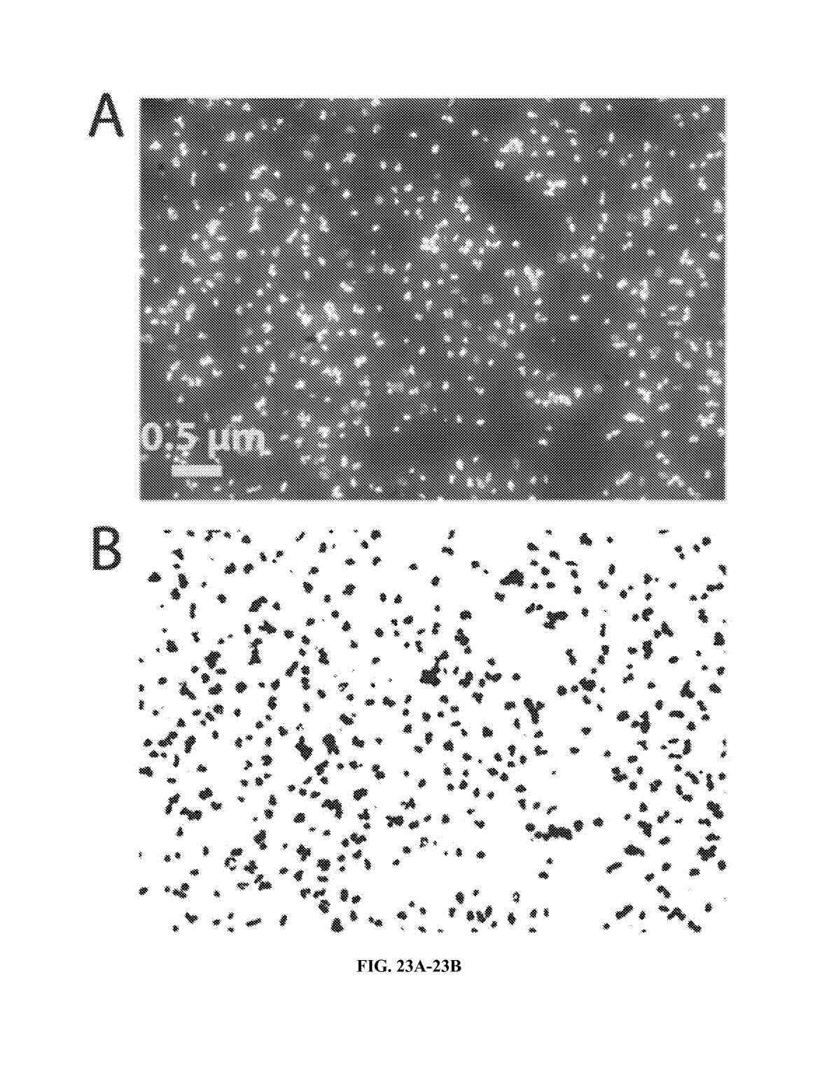

Helium ion irradiation successfully and efficiently generated defects in DNCs.18 Simulations indicate that a single He+ with a few tens of keV energy can generate 20 to 40 vacancies compared to 0.1 to 10 generated by MeV electrons or protons (Ziegler, et al., 2010). The lower energy and dose allowed the use of inexpensive commercial implantation services (Innovion, Core Systems); however, the small penetration depth of He+ at the available keV energy required that the diamond samples be deposited as thin films. The inventors found that DNC fractions deposited by spin-coating on amino-silanized silicon formed dense monolayer films. The amino-terminated silicon promoted adhesion presumably by electrostatic interaction with the net negative charge on the diamond surface. Scanning electron microscopy (SEM; FIG. 23A) and atomic force microscopy (AFM; not shown) images of the spin-coated films confirmed that the DNCs were deposited as monolayers with minimal aggregation. Using these SEM images and the average crystal sizes determined from high-resolution TEM, the inventors also calculated the nanocrystal density of each film to permit comparison of photoluminescence data from each size fraction (FIG. 23B). The spin-coated DNC films were then irradiated with 20 keV He+ and annealed at 800° C. for two hours under high vacuum (10⁻⁷ Torr) to form NV centers with intrinsic substitutional nitrogen present in the crystals. To minimize background emissions from graphite or other contaminants, the annealed samples were thermally oxidized at 465° C. for 30 minutes in pure oxygen.

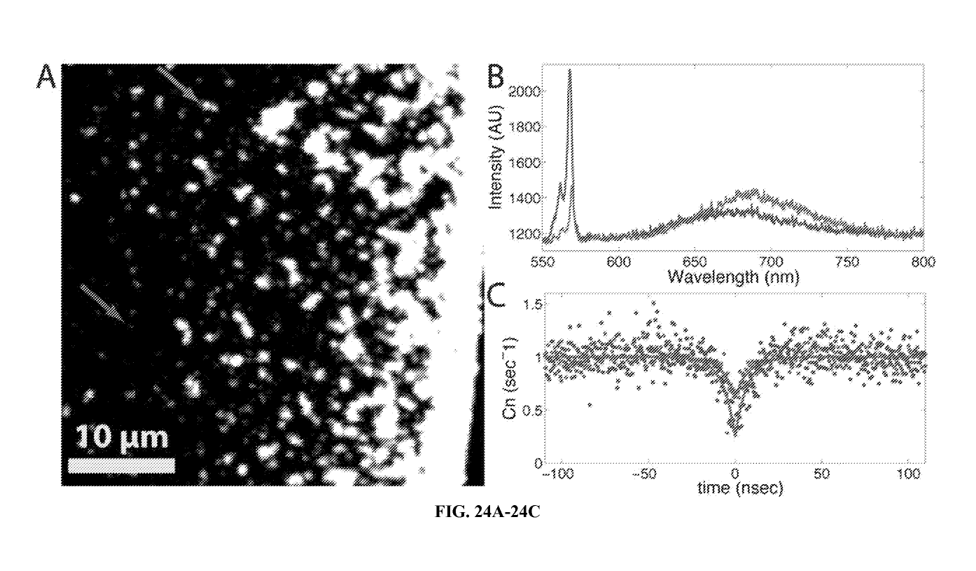

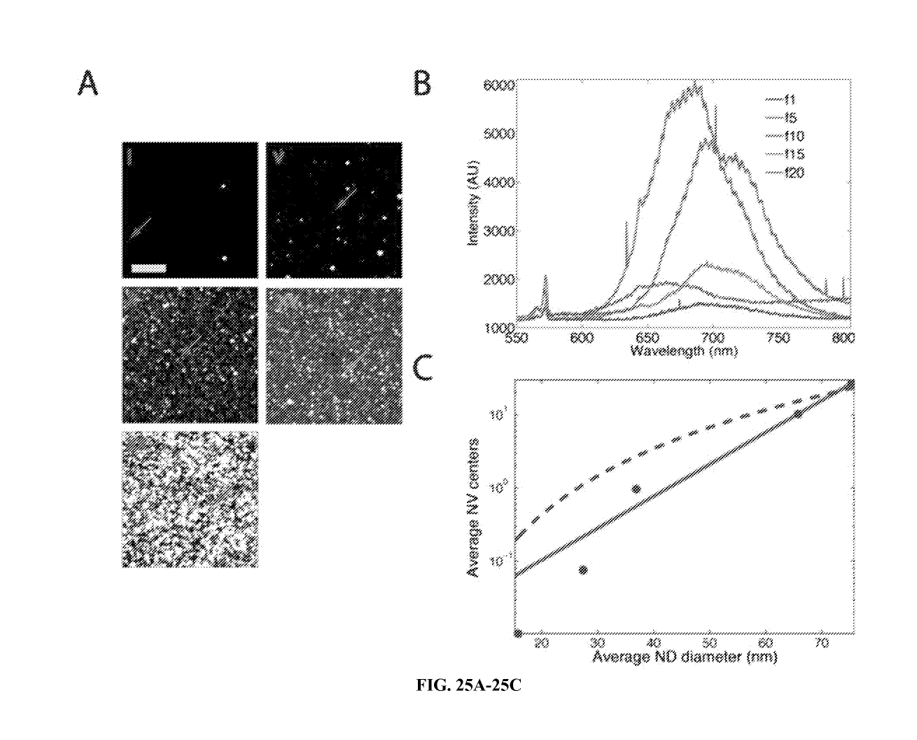

The inventors used the intensity of the luminescence as a measure of the NV content by first measuring the photoluminescence count rate of a known number of NV centers using the confocal microscope (FIG. 24). The autocorrelation function was measured from regions of a sample containing DNCs with a low NV concentration, allowing the count rate per NV center to be estimated. FIGS. 25A and B present confocal fluorescence images and emission spectra of the DNC films after irradiation and annealing. The PL intensities show a clear dependence on the average crystal size. After taking into account the film density and the NV emission rate, the inventors calculated the average number of NV centers per nanocrystal for each sized fraction (FIG. 25C). The error associated with the data points in FIG. 25C is approximately 6% along the y-axis based on fluorescence measurements of ˜10⁵ particles and the standard error of two g⁽²⁾ experiments to correlate NV number with fluorescence counts; while uncertainty along the x-axis ranges from ˜30 to 50% according to the size distribution of each ND fraction as shown in FIG. 22.

The NV concentration the inventors observed for all crystal sizes (<1 ppm) was substantially lower than the typical 200 ppm concentration of nitrogen in the HPHT diamond powder used in this study. Moreover, assuming that the actual number of color centers follows a Poisson distribution, the inventors note that more than 63% of the ˜37 nm nanocrystals contained no NV centers. To rule out the possibility that a failure in the sample preparation was responsible for the low NV yield, the inventors performed the same analysis on a sample of commercially purchased fluorescent DNCs (Academia Sinica) with an average crystal size of 35 nm that was prepared in a similar manner. The inventors observed 0.96 NV centers per particle on average, which matches well with 0.97 NV centers in the 37 nm particles prepared in the study.

### Materials and Methods

Raw material and chemicals-The raw material used for the experiments was HPHT microndiamond powder (Element six PDA999). The powder comprisescrystalline synthetic diamonds with high impact strength,thermal stability and uniformly octahedral shapes in a size range of 210-250 microns and nitrogen at 200 ppm.

Milling-To convert the microdiamond powder into DNCs (<100 nm) inone simple and easy step, the inventors used the ball-milling technique with hardened steel balls (φ=5 mm) in a 50 mL jar. A few grams (2 to 3 grams) of micron-diamond powder were mixed with 5 mL of MilliQ water and 70 g of hardened steel balls (approximately 1:30 diamond:balls) in the jar. The milling process was carried out following an optimized program: 1 hour of milling followed by a 30 minutes break for a total grinding time of 20 hours.

After milling, the inventors obtained a viscous slurry of nanodiamonds contaminated by iron and carbon. The inventors treated the slurry with HCl to dissolve the excess iron; the DNCs appeared to be gray after cleaning with MilliQ water. Afterwards, the DNCs were boiled with a mixture of acids (H2SO4:HNO3:HClO4) (1:1:1 v/v) at 120° C. for 1 hour under redux. The DNCs turned white, which suggested that the non-diamond carbon and all other metal contents that had persisted after the HCl treatment had been removed. Finally, the particles were dispersed in MilliQ water and then centrifuged to form precipitates. The precipitates were collected and dispersed in water again. This rinsing procedure was repeated several times. The as-obtained particles were then dried for the subsequent salt-assisted milling procedure in which 300 mg as-obtained powders were mixed with 2.1 g NaCl and 50 g of steel balls in the jar and milled at 400 rpm for 15 h (1 h intervals with a 30 minutes break). The milled products were then dispersed in HCl solution to remove any iron contaminants. Finally, the particles were dispersed in water after the rinsing procedure.

Fractionation-A customized gradient station and a six-piston fractionator manufactured by BioComp Instruments Inc. (Fredericton, NB, Canada) were used in the fractionation procedure for preparing the density gradients and collecting the fractions, respectively. Centrifugation was carried out in a Thermo Scientific ultracentrifuge (WX Ultra 90) using a Superspin 630 rotor and Nalgene tubes (38 mL, Thermo Scientific). The inventors chose 20-60 wt % sucrose aqueous solutions to prepare the continuous density gradient. A 20 wt % sucrose solution was first laid at the bottom of the centrifuge tube up to the 45% level, with a 12 mL Norm-Ject syringe (Henke Sass Wolf) and a Vita 14 steel needle, and then a 60 wt % sucrose solution of the same volume was slowly injected to the bottom to ensure that there was a sharp interface between the two solutions. Continuous density gradients were obtained through tilted tube rotation using a gradient station with a program: 1^{st} step, 9.5min at tilt angle 50°; 2^{nd} step, 40 s at tilt angle 80°. Then, 1.6 mL of previously prepared DNC solution was laid on the top of the as-prepared gradient solution with a 1.0 mL BD syringe (Becton, Dickinson and Company) and a disposable Pasteur pipette (Fisher Scientific) and the tube was balanced before being placed in the ultracentrifuge. The centrifuge process was carried out at the speed of 20 000 rpm for 30 min. Finally, fractions were collected with a six-piston fractionator. For further characterization and application, the collected fractions were rinsed several times by centrifuging and replacing the solvent with MilliQ water until the density of the final disposed water (measured by a Density Meter, DMA 35) was equal to that of pure water. Fractionated nanodiamonds were stored in ambient condition for further treatment and characterization.

Structural characterization-A high-resolution transmission electron microscope (HRTEM; Titan G2 80-200, FEI Co.) was utilized to investigate the sizes and structures of the primary particles. Aqueous solutions of DNCs were dried on 300 mesh Au grids (Ted Pella Inc., USA) and characterized with an acceleration voltage of 300 kV. The particle size histograms were obtained by counting over 150 particles per sample. The inventors used X-ray diffraction (XRD; Bruker D8 Advance, Cu λKα1=1.5406 Å, increment: 0.1 degree per step, scan speed: 1 second per step) to study the phase purity of the DNCs.

Diamond film preparation and He+ implantation-DNC fractions in a water suspension were deposited on silicon substrates by spincoating at 2000 rpm. To promote adhesion of the DNCs, the substrate was pre-treated with a 2% solution of aminopropyltriethoxysilane (APTES) in ethanol for two minutes, rinsed in water, and heated at 100° C. for 30 minutes. DNCs deposited in this way formed uniformly dispersed monolayer films with minimal aggregation. The DNC density was determined from scanning electron micrographs (SMEs) of the films. Using Image J software, the diamond filling fraction on the underlying substrate was calculated by converting the SEM images into binary black and white using a manually set intensity threshold. The number of DNCs per unit area was determined assuming a square footprint and knowledge of the average size measured from the TEM images.

DNC films were irradiated with 20 keV He+ at a dose of 5.9×1012 ions per cm² using a commercial implantation service (Innovion, San Jose Calif.). The irradiated DNCs were annealed at 800° C. for two hours at a pressure of 7×10⁻⁷ Torr, followed by thermal oxidation at 465° C. for 30 minutes in 100% oxygen at atmospheric pressure. Freely available stopping range in matter (SRIM) software was used to estimate the ion implantation range and concentration of generated vacancies (Ziegler, et al., 2010).

Optical characterization-DNC films were characterized using a home-built confocal microscope. A 532 nm diode pumped solid-state laser was focused onto the samples with an air immersion objective (Olympus LUCPlanFLN 40×0.6 NA), and a steerable mirror (Newport) scanned both the laser and the emitted light. Fluorescence was passed through a dichroic mirror, bandpass filtered (650-800 nm), and coupled to a single-mode optical fiber, which served as the confocal pinhole. Avalanche photo diodes (APD, Perkin Elmer) were used for photo detection and photon statistics. Emission spectra were measured with a grating spectrometer (Jobin Yvon iHR550, 76 mm×76 mm monochromator with 150 g mm⁻¹ grating) and a CCD camera. Extended data acquisition times (30-60 seconds) for spectral measurements increased the frequency of noise originating from cosmic rays. The resulting single point peaks in the spectra were not altered from the raw data because they were distinct from the much broader emission lines of NV centers. Photon autocorrelation functions of single NV centers were measured to determine the luminescence intensity of NVs on the microscope. Fluorescence emissions were split into two channels using a beam splitter and detected with separate avalanche photodiodes in the Hanbury Brown and Twiss configurations. Photon coincidence in each channel as a function of the delay time was analyzed with a time-correlated single photon counting module (Picoharp). The raw coincidence counts, c(t), were normalized to the coincidence rate at long delay times (where single emitters are equivalent to a Poisson distributed source) using the formula C_{N}(t)=c(t)/N₁N₂wT, where N is the detected photon count rate in channels 1 and 2, w is the time bin size, and T is the total acquisition time. Background correction accounting for APD dark counts and non-NV luminescence gave the autocorrelation function g⁽²⁾(t)=[C_{N}(t)−(1−p²)]/p², where p=S/(S+B) is the signal-(S) to-background (B) ratio. The number of NV centers, N, was calculated from the contrast in g⁽²⁾ at zero lag time according to N=1/(1-−g⁽²⁾(0)).

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
Anderson, Experimental Cell Research, 9:446-459, 1955.
Arnold, et al., Nat Nano. 1:60-65, 2006.
Bai, et al., Journal of the American Chemical Society. 132:2333-2337, 2010.
Barnard & Sternberg, J. Mater. Chem. 17:4811-4819, 2007.
Barnard & Zapol, The Journal of Chemical Physics, 121:4276-4283, 2004.
Barnard, Journal of Materials Chemistry. 18:4038-4041, 2008.
Berne & Pecora, Dynamic light scattering: applications to chemistry, biology & physics, 2000.
Bootz, et al., European Journal of Pharmaceutics and Biopharmaceutics. 57:369-375, 2004.
Brakke, Methods in virology, 1967, 2, 93-118, 1967.
Brookes, et al., Eur Biophys J Biophy. 39:405-414, 2010.
Butenko, et al., Fuller Nanotub Car N. 14:557-564, 2006.
Carney, et al., Nat Commun, 2:335, 2011.
Chang, et al., Nanoscale, 3:958-962, 2011.
Chen, et al., ACS Nano. 3:2016-2022, 2009.
Chow, et al., Science Translational Medicine. 3:73ra21, 2011.
Chukhaeva, Phys. Solid State, 2004, 46, 625-628, 2004.
Cölfen & Pauck, Colloid & Polymer Science, 275:175-180, 1997.
Demeler and E. Brookes, Colloid & Polymer Science, 286:129-137, 2008.
Demeler, et al., The UT Health Science Center at San Antonio, Dept. of Biochemistry, 2012.
Feng, et al., J Phys Chem. 115:1752-6, 2011/
Frens, Nature. 241:20-22, 1973.
Ge, et al., Journal of the American Chemical Society. 131:15687-15694, 2009.
Ghosh, S. M. Bachilo and R. B. Weisman, Nat Nano, 2010, 5, 443-450, 2010.
Gibson, et al., Diamond and Related Materials. 18:620-626, 2009.
Girard, et al., Diamond and Related Materials. 19:1117-1123, 2010.
Graham, Biological Centrifugation, Bios, 2001.
Green & Hersam, The Journal of Physical Chemistry Letters, 2009, 1, 544-549, 2009.
Grichko, et al., Nanotechnology. 19:225201, 2008.
Harkness, et al., Nanoscale, 2012.
Jamison, Nanotechnology, 20:355702, 2009.
Jiang & Xu, Carbon. 33:1663-1671, 1995.
Klug & Alexander, X-Ray Diffraction Procedures: For Polycrystalline and Amorphous Materials, 2nd Edition, by Harold P. Klug, Leroy E. Alexander, pp. 992. ISBN 0-471-49369-4. Wiley-VCH, 1974.
Komatsu & Wang, Materials. 3:3818-3844, 2010.
Korobov, et al., Nanoscale. 5:1529-1536, 2013.
Kratky, et al., in enzymology, 27:98-110, 1973
Kruger, et al., Carbon. 43:1722-1730, 2005.
Larionova, et al., Diamond and Related Materials. 15:1804-1808, 2006.
Lees, et al., Nano Letters, 8:2883-2890, 2008.
Liang, et al., Journal of Colloid and Interface Science. 354:23-30, 2011.
Mochalin, et al., Chemistry of Materials. 21:273-279, 2008.
Mochalin, et al., Nat Nano. 7:11-23, 2012.
Murray, et al., Journal of the American Chemical Society. 115:8706-8715, 1993.
Osawa, Diamond and Related Materials. 16:2018-2022, 2007.
Ōsawa, et al., Diamond and Related Materials, 2009, 18, 904-909, 2009.
Ozawa, et al., Advanced Materials. 19:1201-1206, 2007.
Pecora, Journal of Nanoparticle Research, 2:123-131, 2000.
Pentecost, et al., ACS Applied Materials & Interfaces, 2:3289-3294, 2010.
Planken & Cölfen, Nanoscale. 2:1849-1869, 2010.
Schrand, et al., Handbook of Nanoscience, Engineering, & Technology, 3rd ed, 789-866, 2012.
Schrand, S. A. C. Hens and O. A. Shenderova, Crit Rev Solid State, 2009, 34, 18-74, 2009.
Shenderova & Ciftan Hens, in Nanodiamonds, Springer US, ch. 4, pp. 79-116, 2010.
Shenderova, et al., Diamond and Related Materials. 15:1799-1803, 2006.
Shenderova, et al., Diamond and Related Materials. 16:2003-2008, 2007.
Shenderova, et al., The Journal of Physical Chemistry C. 115:19005-19011, 2011.
Steinigeweg, M. Schütz, M. Salehi and S. Schlücker, Small, 2011, 7, 2443-2448, 2011.
Sun, et al., ACS Nano, 2010, 4, 3381-3389, 2010.
Svedberg & Nichols, Journal of the American Chemical Society. 45:2910-2917, 1923.
Talapin, et al., Chemical reviews. 110:389, 2010.
Verma & Stellacci, Small. 6:12-21, 2010.
Williams, et al., ACS Nano. 4:4824-4830, 2010.
Wohlleben, Journal of Nanoparticle Research, 14:1, 2012.
Xu, et al., Journal of Solid State Chemistry, 178:688-693, 2005.

1. A composition comprising purified nanoparticles, wherein the nanoparticles have a size distribution equal to or between 1 and 10 nm.

2. The composition of claim 1, wherein the composition comprises at least, equal to, or between 20 mg and 400 mg of nanoparticles.

3. The composition of claim 1, wherein aggregates of nanoparticles comprise less than 10% by weight of the composition.

4. The composition of claim 1, wherein the size distribution of the nanoparticles has a standard deviation of 1 or less.

5. The composition of claim 1, wherein the nanoparticles have a mean particle size equal to or between 5 nm and 10 nm.

6. The composition of claim 1, wherein the nanoparticles are nanodiamonds.

7. The composition of claim 6, wherein the composition comprises a plurality of nanodiamonds.

8. The composition of claim 7, wherein one or more of the plurality of nanodiamonds has a nitrogen vacancy center.

9. A method of purifying a composition comprising nanoparticles comprising:
centrifuging at least two tubes comprising a first sample comprising nanoparticles to create a density gradient, wherein the at least two tubes are tilted at least 45°; and
collecting a second composition containing purified nanoparticles.

10. The method of claim 9, wherein centrifuging the at least two tubes are tilted equal to or between 50° and 90°.

11. The method of claim 9, further comprising extracting the purified nanoparticles from the second composition.

12-21. (canceled)

22. The method of claim 11, further comprising:
preparing a dispersion comprising the second composition comprising the purified nanoparticles;
centrifuging at least two tubes comprising the dispersion containing purified nanoparticles to create a density gradient, wherein the at least two tubes are tilted at least 45°; and
collecting a third composition containing purified nanoparticles.

23. The method of claim 22, wherein the centrifuging of step (a) is performed at the same speed as the centrifuging of step (e).

24. The method of claim 22, wherein the centrifuging of step (a) is performed at a different speed from the centrifuging of step (e).

25. The method of claim 22, wherein the at least two tubes of step (a) are tilted at the same angle as the at least two tubes of step (e).

26. The method of claim 22, wherein the at least two tubes of step (a) are tilted at a different angle from the at least two tubes of step (e).

27. The method of claim 9, wherein the first sample comprising nanoparticles comprises nanodiamonds.

28. The method of claim 27, wherein the purified nanoparticles comprise one or more diamond nanocrystals (DNCs).

29. The method of claim 28, further comprising:
irradiating the DNCs to produce nitrogen-vacancy centers in one or more of the DNCs.

30. The method of claim 28, further comprising:
preparing a film comprising the DNCs; and
irradiating the DNCs to produce nitrogen-vacancy centers in one or more of the DNCs.
